(19) United States
(12) Patent Application Publication
(10) Pub. No.: US 2012/0287308 A1
(43) Pub. Date: Nov. 15, 2012

(54) ELECTRONIC DEVICE

(75) Inventors: Kazuhiro KOJIMA, Osaka (JP); Haruo HATANAKA, Kyoto City (JP); Shinpei FUKUMOTO, Higashiosaka City (JP)

(73) Assignee: SANYO ELECTRIC CO., LTD., Moriguchi-City (JP)

(21) Appl. No.: 13/105,683

(22) Filed: May 11, 2011

(30) Foreign Application Priority Data
May 11, 2011 (JP) 2010-109141

(51) Int. Cl. H04N 5/262

(52) U.S. Cl. 348/239; 348/E05.051

(57) ABSTRACT

Aan electronic device includes: a focus degree map generation portion that generates a focus degree map indicating a focus degree in each position on an input image; an output image generation portion that performs image processing corresponding to the focus degree map on the input image to generate an output image; and a record control portion that sets the input image or the output image at a record target image and that records the record target image and the focus degree map in a recording medium such that the record target image and the focus degree map are associated with each other or that records the record target image in the recording medium such that the focus degree map is embedded in the record target image.

This nonprovisional application claims priority under 35 U.S.C. §119(a) on Patent Application No. 2010-109141 filed in Japan on May 11, 2010, the entire contents of which are hereby incorporated by reference.

### BACKGROUND OF THE INVENTION

1. Field of the Invention

The present invention relates to electronic devices such as an image sensing device.

2. Description of Related Art

Image sensing devices such as a digital still camera and a digital video camera using a solid-state image sensor such as a CCD (charge coupled device) are widely used at present.

In some shooting targets, it is often desired to acquire a shooting image having a so-called “blurring effect” in which, while a subject in focus is sharply shot, the other subjects are so shot that the images thereof appear blurred, and consequently, the subject in focus is so enhanced as to stand out in the entire image. In order to acquire such a shooting image, it is necessary to use, for example, an image sensing device having a large-sized solid-state image sensor or a large lens aperture. Since this type of image sensing device makes it possible to shoot with sufficiently shallow depth of field, it is possible to acquire a shooting image having a “blurring effect” as described above. However, when a compact image sensing device having a small-sized solid-state image sensor and a small lens aperture is used, it is impossible to shoot with sufficiently shallow depth of field, with the result that it is difficult to acquire a shooting image having a “blurring effect.”

In view of the foregoing, there is proposed a method of generating, with image processing, a blurred image having a “blurring effect” from an original image shot with great depth of field. FIGS. 25A and 25B respectively show an original image 900 and a blurred image 901 as examples of an original image and a blurred image. With such image processing, it is possible to acquire an image having a “blurring effect” even using an image sensing device that cannot shoot with sufficiently shallow depth of field.

The degree indicating how much focus is achieved on an image is referred to as a focus degree. When an output image such as the blurred image 901 is generated from an input image such as the original image 900, for example, a focus degree in each position of the input image is given to an output image generation portion, and thus the output image corresponding to the focus degree can be obtained. Specifically, for example, an image portion having a relatively small focus degree is intentionally blurred, and thus it is possible to make the depth of field of the output image shallower than that of the input image.

In order for a focus degree to be generated based on some focus degree derivation information, an appropriate amount of time (such as computation time) is required. Hence, when a user desires to generate an output image after an input image is shot, the user cannot obtain a focus degree before a lapse of a time period needed for focus degree derivation, and furthermore, the user cannot obtain the output image before a lapse of a time period needed for generation of the output image after the focus degree is obtained. Even when the user simply wants to check the focus state (that is, a focus degree in each position of the input image) of the input image, the user needs to wait for a time period needed for focus degree derivation. Such a long standby period naturally causes the user to have an uncomfortable feeling.

There is a conventional method of embedding, in an original shooting image that is a shooting image where an electronic watermark is to be embedded, a hidden image that is a shooting image other than the original shooting image, as an electronic watermark. This conventional method, however, does not facilitate the reduction of the uncomfortable feeling at all.

### SUMMARY OF THE INVENTION

According to the present invention, there is provided an electronic device including: a focus degree map generation portion that generates a focus degree map indicating a focus degree in each position on an input image; an output image generation portion that performs image processing corresponding to the focus degree map on the input image to generate an output image; and a record control portion that sets the input image or the output image at a record target image and that records the record target image and the focus degree map in a recording medium such that the record target image and the focus degree map are associated with each other or that records the record target image in the recording medium such that the focus degree map is embedded in the record target image.

The significance and effects of the present invention will be further made clear from the description of embodiments below. However, the following embodiments are simply some of embodiments according to the present invention, and the present invention and the significance of the term of each of components are not limited to the following embodiments.

### BRIEF DESCRIPTION OF THE DRAWINGS

FIG. 1 is an entire block diagram schematically showing an image sensing device according to an embodiment of the present invention;

FIG. 2 is a diagram showing the internal configuration of an image sensing portion of FIG. 1;

FIG. 3 is a diagram showing a relationship between a two-dimensional image and an XY coordinate plane;

FIG. 4 is an internal block diagram of a digital focus portion according to the embodiment of the present invention;

FIGS. 5A to 5C are diagrams showing an input image supplied to the digital focus portion of FIG. 4, an output image generated by the digital focus portion and a focus degree image, respectively;

FIGS. 6A and 6B are diagrams illustrating a relationship between an original input image and the output image;

FIGS. 7A and 7B are diagrams illustrating the configuration of image files;

FIGS. 8A and 8B are diagrams showing an example of a record target image a focus degree map;

FIGS. 9A and 9B are diagrams showing another example of the record target image the focus degree map;

FIGS. 10A to 10E are respectively a diagram showing a basic focus degree map, a diagram showing a focus degree histogram in the basic focus degree map, a diagram showing a LUT (lookup table) based on the focus degree histogram, a diagram showing a variation focus degree map obtained with the LUT and a diagram showing a focus degree map reproduced with the LUT;

FIG. 11A is a diagram illustrating a relationship between the original input image and the output image; and FIG. 11B is a diagram illustrating a relationship between a re-input image and the output image;

FIGS. 12A and 12B are diagrams illustrating processing performance information that needs to be kept in the image file;

FIG. 13 is a diagram illustrating link information that needs to be kept in the image file;

FIGS. 14A and 14B are diagrams showing the focus degree map before edition and the edited focus degree map;

FIG. 15 is an internal block diagram of a first output image generation portion that can be employed as the output image generation portion of FIG. 4;

FIG. 16A is a diagram showing a relationship between a focus degree and a blurring degree specified by the conversion table of FIG. 15; and FIG. 16B is a diagram showing a relationship between a focus degree and an edge emphasizing degree specified by the conversion table of FIG. 15;

FIG. 17 is an internal block diagram of a second output image generation portion that can be employed as the output image generation portion of FIG. 4;

FIG. 18 is a diagram showing a relationship between a focus degree and a combination ratio specified by the conversion table of FIG. 17;

FIG. 19A is a diagram showing a pattern of a typical brightness signal in a focused part on the input image; and FIG. 19B is a diagram showing a pattern of a typical brightness signal in an unfocused part on the input image;

FIG. 20 is a block diagram of portions involved in deriving an extension edge difference ratio that can be used as the focus degree;

FIG. 21 is a diagram showing how the brightness difference value of an extremely local region, the brightness difference value of a local region and an edge difference ratio are determined from the brightness signal of the input image;

FIG. 22 is a diagram illustrating the outline of extension processing performed by the extension processing portion of FIG. 20;

FIGS. 23A and 23H are diagrams illustrating a specific example of the extension processing performed by the extension processing portion of FIG. 20;

FIG. 24 is a block diagram of portions involved in deriving an extension frequency component ratio that can be used as the focus degree; and

FIGS. 25A and 25B are respectively a diagram showing an original image obtained by shooting and a diagram showing a blurred image obtained by blurring part of the original image with image processing, in a conventional technology.

### DETAILED DESCRIPTION OF PREFERRED EMBODIMENTS

Some embodiments of the present invention will be specifically described below with reference to the accompanying drawings. In the referenced drawings, like parts are identified with like symbols, and their description will not be repeated in principle. First to fifth embodiments will be described later; what are common in each embodiment or what are referenced in the description of each embodiment will first be described. For ease of description, in the present specification, a symbol is referenced, and thus the name corresponding to the symbol may be omitted or simply expressed. For example, when an input image is represented by symbol 210, the input image 210 may be expressed as the image 210.

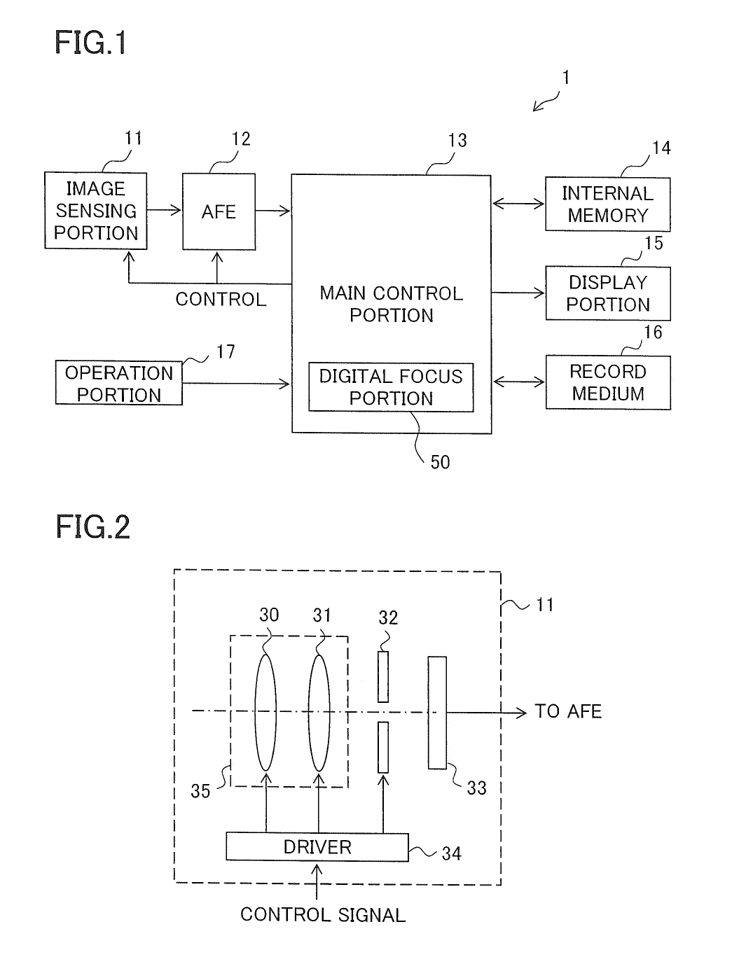

FIG. 1 is an entire block diagram schematically showing an image sensing device 1 according to an embodiment of the present invention. The image sensing device 1 is either a digital still camera that can shoot and record a still image or a digital video camera that can shoot and record a still image and a moving image.

The image sensing device 1 includes an image sensing portion 11, an AFE (analog front end) 12, a main control portion 13, an internal memory 14, a display portion 15, a recording medium 16 and an operation portion 17.

In FIG. 2, a diagram showing the internal configuration of the image sensing portion 11 is shown. The image sensing portion 11 includes an optical system 35, an aperture 32, an image sensor 33 formed with a CCD (charge coupled device), a CMOS (complementary metal oxide semiconductor) image sensor or the like and a driver 34 that drives and controls the optical system 35 and the aperture 32. The optical system 35 is formed with a plurality of lenses including a zoom lens 30 and a focus lens 31. The zoom lens 30 and the focus lens 31 can move in the direction of an optical axis. The driver 34 drives and controls, based on a control signal from the main control portion 13, the positions of the zoom lens 30 and the focus lens 31 and the degree of opening of the aperture 32, and thereby controls the focal length (angle of view) and the focus position of the image sensing portion 11 and the amount of light entering the image sensor 33.

The image sensor 33 photoelectrically converts an optical image that enters the image sensor 33 through the optical system 35 and the aperture 32 and that represents a subject, and outputs to the AFE 12 an electrical signal obtained by the photoelectrical conversion. Specifically, the image sensor 33 has a plurality of light receiving pixels that are two-dimensionally arranged in a matrix, and each of the light receiving pixels stores, in each round of shooting, a signal charge having the amount of charge corresponding to an exposure time. Analog signals having a size proportional to the amount of stored signal charge are sequentially output to the AFE 12 from the light receiving pixels according to drive pulses generated within the image sensing device 1.

The AFE 12 amplifies the analog signal output from the image sensing portion 11 (image sensor 33), and converts the amplified analog signal into a digital signal. The AFE 12 outputs this digital signal as RAW data to the main control portion 13. The amplification factor of the signal in the AFE 12 is controlled by the main control portion 13.

The main control portion 13 is composed of a CPU (central processing unit), a ROM (read only memory), a RAM (random access memory) and the like. The main control portion 13 generates, based on the RAW data from the AFE 12, an image signal representing an image (hereinafter also referred to as a shooting image) shot by the image sensing portion 11. The image signal generated here includes, for example, a brightness signal and a color-difference signal. The RAW data itself is one type of image signal. The main control portion 13 also functions as display control means for controlling the details of a display on the display portion 15, and performs control necessary for display on the display portion 15.

The internal memory 14 is formed with an SDRAM (synchronous dynamic random access memory) or the like, and temporarily stores various types of data generated within the image sensing device 1. The display portion 15 is a display device composed of a liquid crystal display panel and the like, and displays, under control by the main control portion 13, a shot image, an image recorded in a recording medium 16 or the like. The recording medium 16 is a nonvolatile memory such as a card semiconductor memory or a magnetic disk, and stores a shooting image and the like under control by the main control portion 13. The operation portion 17 receives an operation from the outside. The details of the operation performed on the operation portion 17 are transmitted to the main control portion 13.

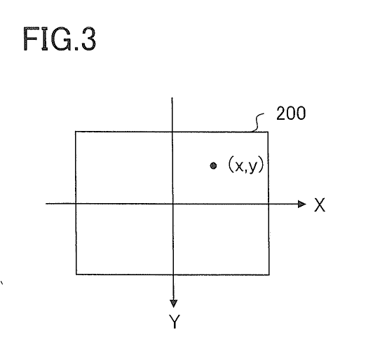

FIG. 3 shows an XY coordinate plane that is a two-dimensional coordinate plane on which an arbitrary two-dimensional image is to be arranged. In FIG. 3, a rectangular frame represented by symbol 200 indicates an outer frame of the two-dimensional image. The XY coordinate plane has, as coordinate axes, an X axis extending in a horizontal direction of the two-dimensional image 200 and a Y axis extending in a vertical direction of the two-dimensional image 200. All images described in the present specification are two-dimensional images unless otherwise particularly described. The position of a noted point on the XY coordinate plane and the two-dimensional image 200 is represented by (x, y). The X axis coordinate value of the noted point and the horizontal position of the noted point on the XY coordinate plane and the two-dimensional image 200 are represented by “x.” The Y axis coordinate value of the noted point and the vertical position of the noted point on the XY coordinate plane and the two-dimensional image 200 are represented by “y.” On the XY coordinate plane and the two-dimensional image 200, the positions of pixels adjacent to the right side of, the left side of, the bottom side of and the top side of a pixel arranged in the position (x, y) are (x+1, y), (x−1, y), (x, y+1) and (x, y−1), respectively. The position where a pixel is arranged is also simply referred to as a pixel position. In the present specification, the pixel arranged in the pixel position (x, y) may also be represented by (x, y). An image signal for a pixel is also particularly referred to as a pixel signal; the value of the pixel signal is also referred to as a pixel value.

The image sensing device 1 controls the position of the focus lens 31 and thereby can form an optical image of a main subject on the image sensing surface of the image sensor 33. Incident light from a spot light source regarded as the main subject forms an image at an imaging point through the optical system 35; when the imaging point is present on the image sensing surface of the image sensor 33, the main subject is exactly in focus. When the imaging point is not present on the image sensing surface of the image sensor 33, the image from the spot light source is blurred on the image sensing surface (that is, an image having a diameter exceeding the diameter of a permissible circle of confusion is formed). In this state, the main subject is out of focus or the main subject is somewhat clearly in focus but is not exactly in focus. In the present specification, the degree indicating how much focus is achieved is referred to as a focus degree. It is assumed that, as the focus degree of a noted region or a noted pixel is increased, a subject in the noted region or the noted pixel is brought in focus more clearly (as the subject is brought in focus more clearly, the diameter mentioned above is decreased). A portion where the degree with which focus is achieved is relatively high is referred to as a focused part; a portion where the degree with which focus is achieved is relatively low is referred to as an unfocused part.

Incidentally, the image sensing device 1 has the feature of generating, with image processing, an output image having a “blurring effect” from an input image that is not shot with sufficiently shallow depth of field.

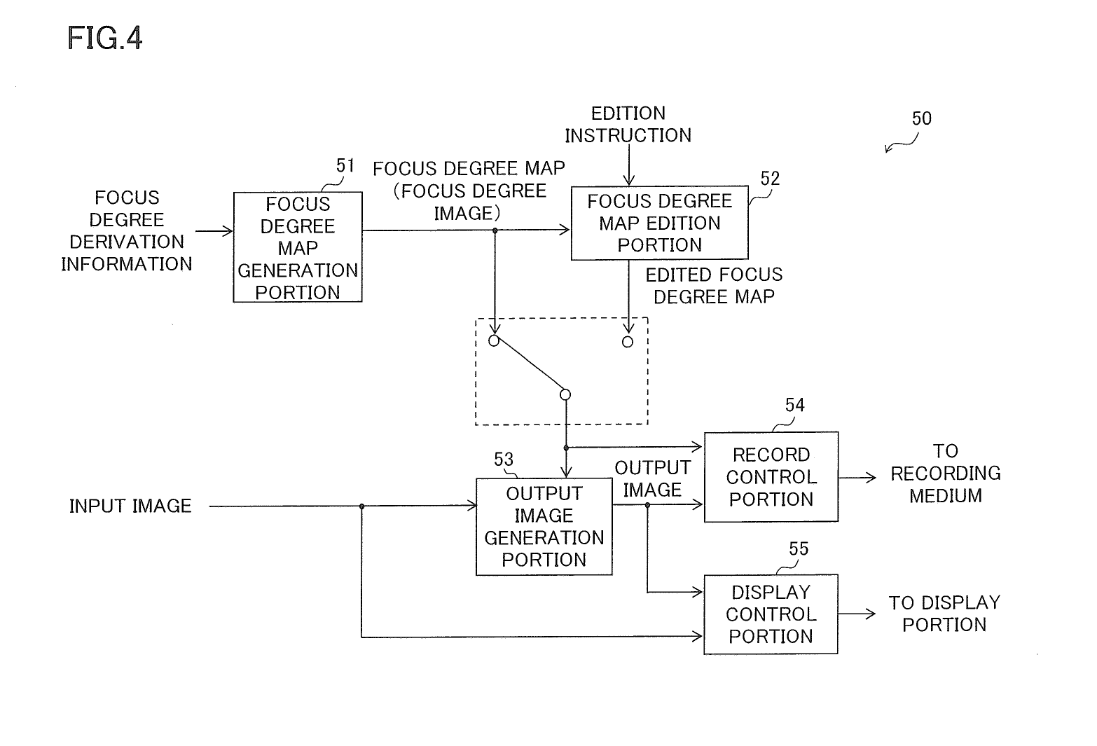

This feature is achieved by a digital focus portion 50 present in the main control portion 13 of FIG. 1. FIG. 4 shows an internal block diagram of the digital focus portion 50. The digital focus portion 50 includes a focus degree map generation portion 51, a focus degree map edition portion 52, an output image generation portion 53, a record control portion 54 and a display control portion 55. An image signal of an input image is supplied to the digital focus portion 50. For example, the input image is a shooting image that is a still image resulting from shooting by the image sensing portion 11. Alternatively, each frame (in other words, a frame image) of a moving image resulting from shooting by the image sensing portion 11 may be the input image.

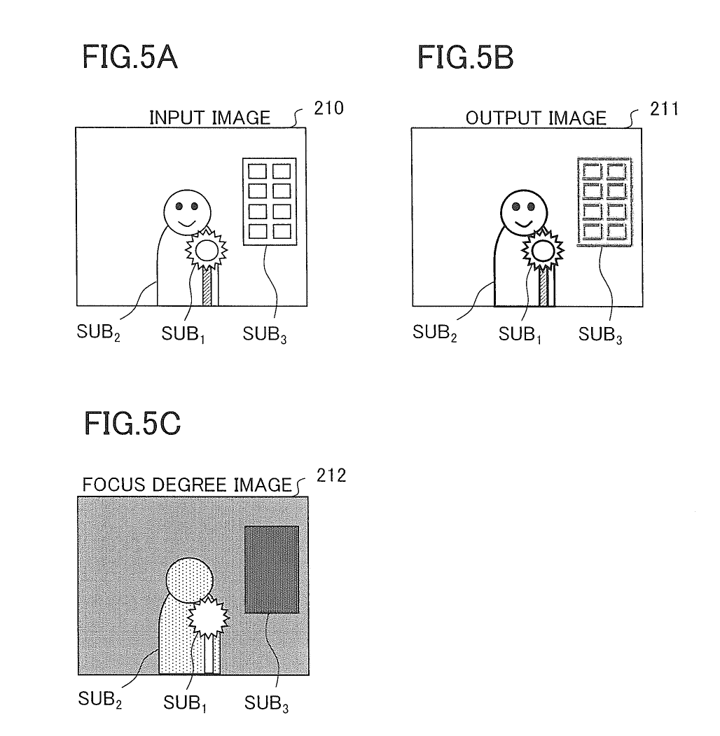

FIG. 5A shows an input image 210 that is an example of the input image. The input image 210 is an image that is shot to include, as subjects, a flower SUB₁, a person SUB₂ and a building SUB₃. It is assumed that, when the subject distances of the flower SUB₁, the person SUB₂ and the building SUB₃ are represented by d₁, d₂ and d₃, respectively, an inequality “d₁<d₂<d₃” holds true. The subject distance d₁ of the flower SUB₁ refers to a distance in an actual space between the flower SUB₁ and the image sensing device 1 (the same is true for the subject distances d₂ and d₃).

The focus degree map generation portion 51 derives, based on focus degree derivation information, the focus degrees of individual pixel positions of the input image, and generates and outputs a focus degree map in which the focus degrees of individual pixel positions are written and arranged on the XY coordinate plane. The focus degree derivation information can take various forms. For example, the edge state of the input image or distance information on each pixel position can be used as the focus degree derivation information; a specific example of the focus degree derivation information will be described later.

An image obtained by regarding the focus degree map as an image is referred to as a focus degree image. The focus degree map can be said to be equivalent to the focus degree image. Hence, in the following description, the focus degree map can be replaced, as appropriate, by the focus degree image, or the focus degree image can be replaced by the focus degree map. The focus degree image is a gray scale image that has the focus degree of the pixel position (x, y) as the pixel value of the pixel position (x, y). FIG. 5C shows a focus degree image 212 with respect to the input image 210 of FIG. 5A. In drawings, including FIG. 5C, that represent the focus degree image or the focus degree map, a portion having a larger focus degree is shown in a more whitish color and a portion having a smaller focus degree is shown in a more blackish color. However, in the drawings representing the focus degree image or the focus degree map, in order to clarify a boundary (for example, a boundary between the flower SUB₁ and the person SUB₂) between different subjects, a black boundary line is drawn in the boundary regardless of focus degree.

The focus degrees of portions where the image signals of the flower SUB₁, the person SUB₂ and the building SUB₃ are present are represented by F₁, F₂ and F₃, respectively. It is assumed that, when the input image 210 is shot, the flower SUB₁ is brought in focus most clearly, and consequently, an inequality “F₁>F₂>F₃” holds true. It is assumed that the difference between the subject distances d₁ and d₂ is small, and consequently, the difference between the focus degrees F₁ and F₂ is small. On the other hand, it is assumed that the difference between the subject distances d₂ and d₃ is very large, and consequently, the difference between the focus degrees F₂ and F₃ is very large. Hence, the flower SUB₁ and the person SUB₂ are the focused part, and the building SUB₃ is the unfocused part.

In the focus degree map, the value of a portion of the main subject that is in focus is large, and the value of a portion of a background that is not in focus is small. Hence, the focus degree map is also said to represent the distribution of a possibility that the main subject or the background is present. A distance map in which the maximum value is given to a subject portion of a subject distance that is exactly in focus and in which lower values are given to the other subject portions that are more unclearly in focus can also be considered to be the focus degree map.

When the user provides an edition instruction, the focus degree map edition portion 52 edits, based on the edition instruction, the focus degree map generated by the focus degree map generation portion 51, and then outputs the edited focus degree map. The user uses the operation portion 17 and thereby can provide an arbitrary instruction including the edition instruction to the image sensing device 1. Alternatively, when the display portion 15 has a touch panel function, the user can also provide, by performing a touch panel operation, an arbitrary instruction including the edition instruction to the image sensing device 1. In the following description, the focus degree map generated by the focus degree map generation portion 51 may be referred to as a focus degree map before edition.

The output image generation portion 53 performs, on the input image, image processing based on the focus degree map, and thereby generates an output image having a so-called “blurring effect.” This image processing is performed, and thus, for example, the subject of an image portion having a relatively large focus degree among a plurality of subjects appearing in the input image is visually enhanced as compared with the subject of an image portion having a relatively small focus degree (an image before the enhancement is the input image; an enhanced image is the output image). Specifically, for example, an image within an image region having a relatively small focus degree is blurred using an averaging filter or the like, and thus the enhancement described above is achieved. The image processing described above and performed by the output image generation portion 53 is particularly referred to as output image generation processing. With the output image generation processing, it is possible to change the depth of field between the input image and the output image. With the output image generation processing, it is also possible to change the focus distance between the input image and the output image. The focus distance of the input image refers to the subject distance of a subject in focus on the input image; the focus distance of the output image refers to the subject distance of a subject in focus on the output image.

When the edition instruction is not provided, the output image generation portion 53 uses the focus degree map before edition output from the focus degree map generation portion 51, and thereby can generates the output image whereas when the edition instruction is provided, the output image generation portion 53 uses the edited focus degree map output from the focus degree map edition portion 52, and thereby can generate the output image.

FIG. 5B shows an output image 211 based on the input image 210 of FIG. 5A. While the focus degrees F₁ and F₂ of the flower SUB₁ and the person SUB₂ are relatively large, the focus degree F₃ of the building SUB₃ is relatively small, and consequently, in the output image 211, the image of the building SUB₃ is blurred, with the result that the flower SUB₁ and the person SUB₂ appear to stand out.

The record control portion 54 produces an image file within the recording medium 16, and writes necessary information into the image file within the recording medium 16, and thereby records the necessary information into the recording medium 16. In other words, the record control portion 54 keeps the image file storing the necessary information in the recording medium 16, and thereby records the necessary information into the recording medium 16. The necessary information here includes all or part of the image signal of the input image, the image signal of the output image, the focus degree map before edition and the edited focus degree map. In the following description, the image file refers to the image file produced within the recording medium 16 unless otherwise particularly described. In the present specification, the recording, the keeping and the storage of an image or arbitrary piece of information (signal or data) have the same meaning; the recording, the keeping and the storage refer to recording, keeping and storage in the recording medium 16 or in the image file unless otherwise particularly described. The recording, the keeping and the storage of the image signal of a noted image may be simply expressed as the recording, the keeping and the storage of the noted image. The operation of the record control portion 54 will be described in detail later.

The display control portion 55 displays the input image, the output image or the focus degree image on the display portion 15. Among the input image, the output image and the focus degree image, two or three can also be simultaneously displayed on the display portion 15. When the input image is displayed on the display portion 15, the entire input image can be displayed on the display portion 15 or part of the input image can be displayed on the display portion 15 (the same is true for the display of the output image or the focus degree image).

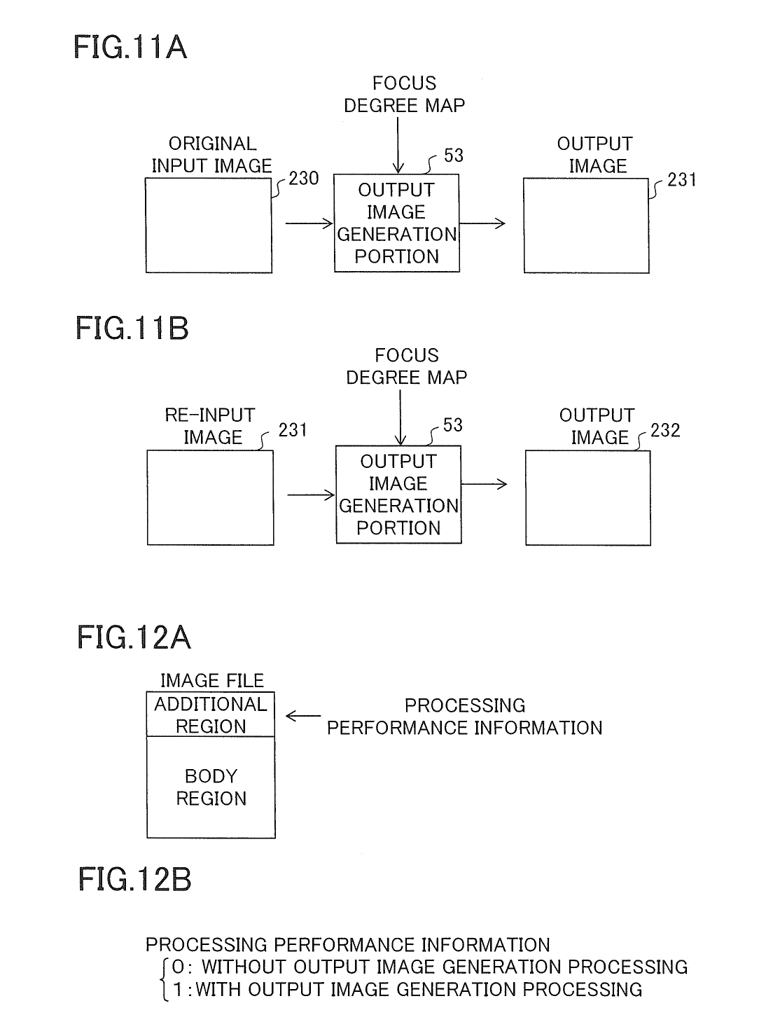

The image obtained by performing the output image generation processing can be input again to the output image generation portion 53 as the input image. In the following description, an input image on which the output image generation processing has not been performed may be particularly referred to an original input image. When an input image is simply described below, it is interpreted as the original input image; it is also possible to interpret it as an image (for example, a re-input image 231 that is shown in FIG. 11B and described later) on which the output image generation processing has been performed one or more times.

Element technologies and the like that can be employed in the image sensing device 1 will be described below in the first to fifth embodiments. Unless a contradiction arises, what is described in an embodiment can be freely combined with what is described in another embodiment and they can be practiced.

### First Embodiment

The first embodiment of the present invention will be described. In the first embodiment, the overall basic operation of the digital focus portion 50 will be described.

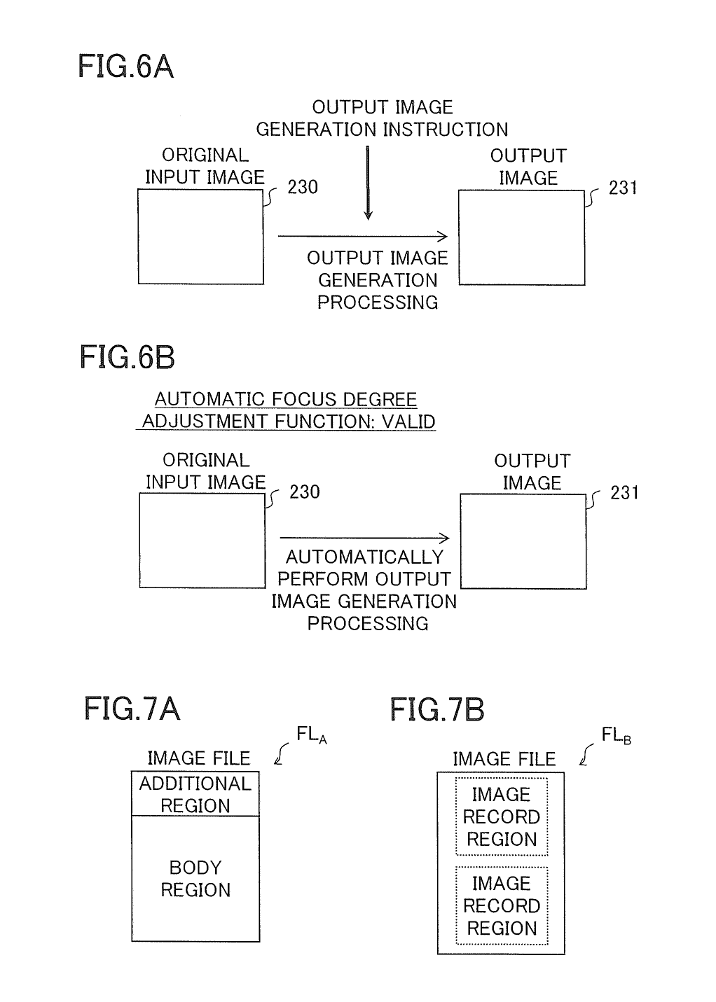

Reference is made to FIG. 6A. When an original input image 230 is acquired by shooting, the original input image 230 is set at a record target image in principle. The record control portion 54 of FIG. 4 records the record target image and the focus degree map in the recording medium 16 with the record target image and the focus degree map associated with each other, or the record control portion 54 records the record target image in the recording medium 16 with the focus degree map embedded in the record target image. The focus degree map here is either the focus degree map before edition or the edited focus degree map.

After the recording of the original input image 230, the user can provide an output image generation instruction, using the operation portion 17 or the like (see FIG. 6A). When the output image generation instruction is provided, the output image generation portion 53 reads the focus degree map and the original input image 230 recorded in the recording medium 16 from the recording medium 16, performs, on the read original input image 230, the output image generation processing based on the read focus degree map and thus generates an output image 231. When the output image 231 is generated, the user can freely change the focus degree map read from the recording medium 16 by providing the edition instruction; when this edition instruction is provided, the edited focus degree map is used to generate the output image 231.

When the output image 231 is generated, the record control portion 54 sets the output image 231 at the record target image, and records again the record target image and the focus degree map in the recording medium 16 with the record target image and the focus degree map associated with each other, or records again the record target image in the recording medium 16 with the focus degree map embedded in the record target image (the focus degree map here is also either the focus degree map before edition or the edited focus degree map). When the output image 231 is recorded, the original input image 230 recorded in the recording medium 16 may be deleted from the recording medium 16 or the recording of the original input image 230 may be held.

Before the acquisition of the original input image 230, the user can make an automatic focus degree adjustment function valid. The user uses the operation portion 17 or the like, and thereby can set the automatic focus degree adjustment function valid or invalid. With the automatic focus degree adjustment function valid, when the original input image 230 is obtained, the output image generation portion 53 performs the output image generation processing on the original input image 230 regardless of whether the output image generation instruction is provided, and generates the output image 231 (see FIG. 6B). The output image generation processing performed when the automatic focus degree adjustment function is valid is generally conducted based on the focus degree map before edition; whether the edition instruction is provided is checked and then the output image generation processing is performed, and thus the output image generation processing can also be performed based on the edited focus degree map.

When automatic focus degree adjustment function is valid, the record control portion 54 sets the output image 231 at the record target image, and records the record target image and the focus degree map in the recording medium 16 with the record target image and the focus degree map associated with each other, or records the record target image in the recording medium 16 with the focus degree map embedded in the record target image (the focus degree map here is also either the focus degree map before edition or the edited focus degree map).

In order to adjust the quality (such as the depth of field) of the record target image read from the recording medium 16, the user can utilize the output image generation processing based on the focus degree map. The focus degree map is displayed on the display portion 15, and thus it is possible to check the focus state of the record target image (input image). On the other hand, an appropriate amount of time is required for generation of the focus degree map. Hence, if the focus degree map is not kept in the recording medium 16, it is necessary to generate the focus degree map each time an attempt to perform the output image generation processing or check the focus state is made. In other words, it is difficult to quickly perform the output image generation processing or check the focus state. In view of the foregoing, when the image sensing device 1 records the record target image, the image sensing device 1 also records the corresponding focus degree map. Thus, it is possible to quickly perform, as necessary, the output image generation processing or check the focus state.

When the focus degree derivation information is the image signal of the original input image, only the image signal of the original input image is kept in the recording medium 16 at the time of acquisition of the original input image, and thereafter the focus degree map can also be generated from the image signal of the original input image read from the recording medium 16 as necessary. However, depending on the record mode of the image signal, part of information on the original input image may be missed at the time of recording of the original input image. When such missing occurs, it is difficult to generate, from record signal, the focus degree map that accurately corresponds to the intrinsically original input image. It is understood from this that it is advantageous to additionally record the focus degree map when the image signal is recorded.

The user can edit the focus degree map as necessary, and this makes it possible to generate the output image having the desired focus state.

The focus degree map that is recorded is the focus degree map before edition in principle; when the edited focus degree map has been generated by provision of the edition instruction, instead of the focus degree map before edition or in addition to the focus degree map before edition, the edited focus degree map is recorded in the recording medium 16. In this case, the record target image and the edited focus degree map are also recorded in the recording medium 16 with the record target image and the edited focus degree map associated with each other, or the record target image is recorded in the recording medium 16 with the edited focus degree map embedded in the record target image. The edition of the focus degree map is, for example, to increase the focus degree of a first specification position in the focus degree map before edition from a certain focus degree to another focus degree and to decrease the focus degree of a second specification position in the focus degree map before edition from a certain focus degree to another focus degree. When the details of such edition are not kept, it is difficult for user to reproduce the same details of the edition later; even if they can be reproduced, a large burden of the reproduction is placed on the user. In the image sensing device 1, since, when the focus degree map is edited, the edited focus degree map is kept and thereafter it can be freely read, the details of the edition are easily and accurately reproduced, and simultaneously the burden on the user is also reduced.

### Second Embodiment

The second embodiment of the present invention will be described. As a specific method of recording the focus degree map that can be employed in the record control portion 54 of FIG. 4, first to fourth focus degree map recording methods will be described by way of example.

—First Focus Degree Map Recording Method—

The first focus degree map recording method will be described. In the first focus degree map recording method, FL_{A} shown in FIG. 7A is assumed to represent an image file. In the record region of the image file FL_{A}, a body region and an additional region are provided. Depending on the file standard, for example, the additional region is referred to as a header region or a footer region. The record control portion 54 keeps the record target image in the body region of the image file FL_{A}, and keeps the focus degree map in the additional region of the image file FL_{A}.

Since the body region and the additional region within the common image file FL_{A} are record regions that are associated with each other, the record target image and the focus degree map are naturally associated with each other. In other words, the record target image and the focus degree map are recorded in the recording medium 16 with the record target image and the focus degree map associated with each other.

Not only the focus degree map but also the thumbnail image and the like of the record target image are kept in the additional region. The thumbnail image of the record target image is an image obtained by reducing the size of the record target image; a thumbnail record region for keeping the image signal of the thumbnail image is provided in the additional region of the image file FL_{A}. Depending on the file standard, two or more thumbnail record regions may be provided in the additional region of the image file FL_{A}. In this case, the thumbnail image of the record target image may be kept in one of the thumbnail record regions (for example, a first thumbnail record region) within the additional region, and the focus degree map (that is, the focus degree image) may be kept in the other thumbnail record region (for example, a second thumbnail record region).

—Second Focus Degree Map Recording Method—

The second focus degree map recording method will be described. In the second focus degree map recording method, FL_{B} shown in FIG. 7B is assumed to represent an image file. The file format of the image file FL_{B} is also referred to as a multi-picture format; a plurality of image record regions for recording a plurality of sheets of images are provided in the image file FL_{B}. First and second image record regions different from each other are included in the image record regions. The record control portion 54 keeps the record target image in the first image record region of the image file FL_{B} and keeps the focus degree map in the second image record region of the image file FL_{B}.

Since the image record regions within the common image file FL_{B} are record regions that are associated with each other, the record target image and the focus degree map are naturally associated with each other. In other words, the record target image and the focus degree map are recorded in the recording medium 16 with the record target image and the focus degree map associated with each other.

—Third Focus Degree Map Recording Method—

The third focus degree map recording method will be described. In the third focus degree map recording method, the focus degree map is embedded in the record target image using an electronic watermark, and the record target image in which the focus degree map is embedded is kept in the image file. In the other words, the record target image is recorded in the recording medium 16 with the focus degree map embedded in the record target image using the electronic watermark. The embedding method differs according to the resolution and the gradation of the focus degree map. Specific examples of the embedding method will be described below one by one. Since the focus degree map should also be said to be the focus degree image, in the following description, a position on the focus degree map may also be referred to as a pixel position.

First Embedding Method

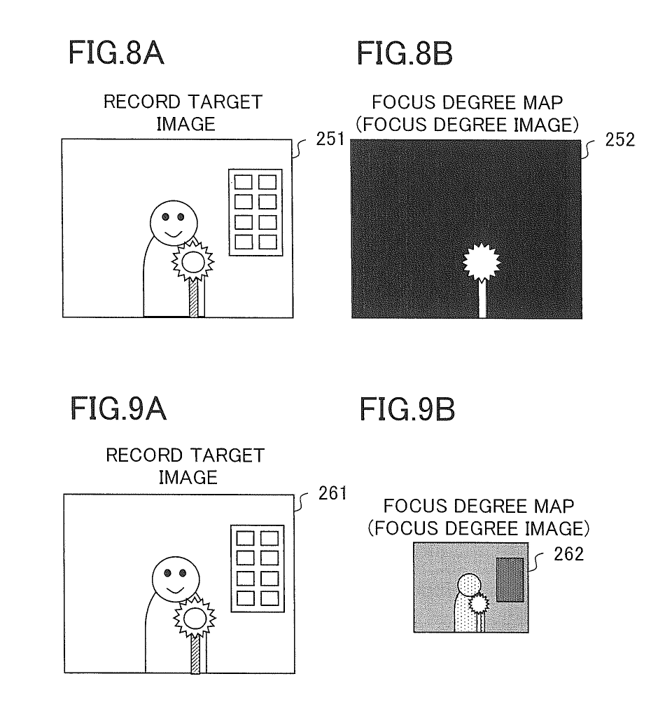

The first embedding method will be described. In the first embedding method, the resolution of the record target image and the resolution of the focus degree map are assumed to be equal to each other. In other words, the size of the record target image and the size of the focus degree image that is the focus degree map are assumed to be equal to each other. Moreover, the focus degree of each pixel position on the focus degree map is assumed to be represented by one bit. In other words, the number of gradation levels of the focus degree map is assumed to be two. In this case, the focus degree image that is the focus degree map is a binarized image, and the pixel signal of each pixel position of the focus degree image is one-bit digital data. Reference numeral 252 shown in FIG. 8B represents an example of the focus degree map (focus degree image) under these assumptions; reference numeral 251 shown in FIG. 8A represents an example of the record target image corresponding to the focus degree map 252.

The pixel signal of each pixel position of the record target image is formed with BB-bit digital data (BB is an integer equal to or greater than 2; for example, 16). It is assumed that, in a certain pixel of the record target image, when the image of such a pixel is changed relatively significantly (for example, brightness is changed relatively significantly), this change causes higher-order bits on the BB-bit digital data to be changed whereas when the image of such a pixel is changed relatively slightly (for example, brightness is changed relatively slightly), this change causes only lower-order bits on the BB-bit digital data to be changed. In this case, in the first embedding method, the pixel signal of the pixel position (x, y) of the focus degree image that is the focus degree map is embedded in the least significant bit (the lowest bit) of the pixel signal of the pixel position (x, y) of the record target image. In other words, the pixel signal of the pixel position (x, y) of the focus degree image is substituted into the least significant bit (the lowest bit).

When the number of gradation levels of the focus degree map is more than two, it is preferable to use a plurality of lower-order bits of each pixel signal of the record target image. For example, when the number of gradation levels of the focus degree map is four (that is, when the pixel signal of each pixel position of the focus degree image is two-bit digital data), the pixel signal of the pixel position (x, y) of the focus degree image that is the focus degree map is preferably embedded in the lower-order two bits of each pixel signal of the record target image.

In general, in the first embedding method, the following embedding is performed. When the number of gradation levels of the focus degree map is 2^{N} (that is, when the pixel signal of each pixel position of the focus degree image is N-bit digital data), the pixel signal of the pixel position (x, y) of the focus degree image that is the focus degree map is embedded in the lower-order N bits of each pixel signal of the record target image (where N is a natural number). When this type of embedding is performed, though the quality of the record target image is slightly degraded, it is unnecessary to additionally provide a record region for keeping the focus degree map. After the image file of the record target image is kept, the digital focus portion 50 reads, as necessary, the lower-order N bits of each pixel signal of the record target image from the image file of the record target image, and thus it is possible to obtain the focus degree map. Although the size of the record target image is assumed to be equal to the size of the focus degree image, even when the latter is smaller than the former, it is possible to utilize the first embedding method.

Second Embedding Method

The second embedding method will be described. In the second embedding method, the resolution of the focus degree map is assumed to be smaller than that of the record target image. In other words, the size of the focus degree image that is the focus degree map is assumed to be smaller than that of the record target image. For specific description, it is assumed that the resolution of the focus degree map is half as large as that of the record target image. Moreover, it is assumed that the number of gradation levels of the focus degree map is equal to or less than 16. In this case, one pixel signal of the focus degree image is digital data of four bits or less. Reference numeral 262 shown in FIG. 9B represents an example of the focus degree map (focus degree image) under these assumptions; reference numeral 261 shown in FIG. 9A represents an example of the record target image corresponding to the focus degree map 262.

In this case, the least significant bits (the lowest bits) of the pixel signals of four pixels on the record target image are combined to form a four-bit data region, and the pixel signal of one pixel position of the focus degree image is embedded in the four-bit data region. In other words, the pixel signal of one pixel position of the focus degree image is substituted into the four-bit data region. Specifically, for example, the least significant bits (the lowest bits) of the pixel signals of pixels positions (x, y), (x+1, y), (x, y+1) and (x+1, y+1) of the record target image are combined to form a four-bit data region, and the pixel signal of the pixel position (x, y) of the focus degree image that is digital data of four bits or less is embedded in the four-bit data region.

The values described above can be changed variously. In general, in the second embedding method, the following embedding is performed. When the number of gradation levels of the focus degree map is 2^{N}, the pixel signal of one pixel of the focus degree image is embedded in the lower-order O bits of M pixels of the record target image (where N, M and O are natural numbers, and N≦M×O is satisfied). After the image file of the record target image is kept, the digital focus portion 50 reads, as necessary, the lower-order O bits of each pixel signal of the record target image from the image file of the record target image, and thus it is possible to obtain the focus degree map.

Third Embedding Method

The third embedding method will be described. In the third embedding method, the resolution of the record target image and the resolution of the focus degree map are assumed to be equal to each other. In other words, the size of the record target image and the size of the focus degree image that is the focus degree map are assumed to be equal to each other. Moreover, the number of gradation levels of the focus degree map is assumed to be 128. In this case, the pixel signal of each pixel position of the focus degree image is seven-bit digital data. When the seven-bit digital data itself is embedded in the image signal of the record target image, the quality of the record target image is degraded too much. Hence, in the third embedding method, the main gradation levels (dominant gradation levels in the focus degree map) are extracted from the 128 gradation levels, and only the focus degree information on the main gradation levels is embedded in the image signal of the record target image.

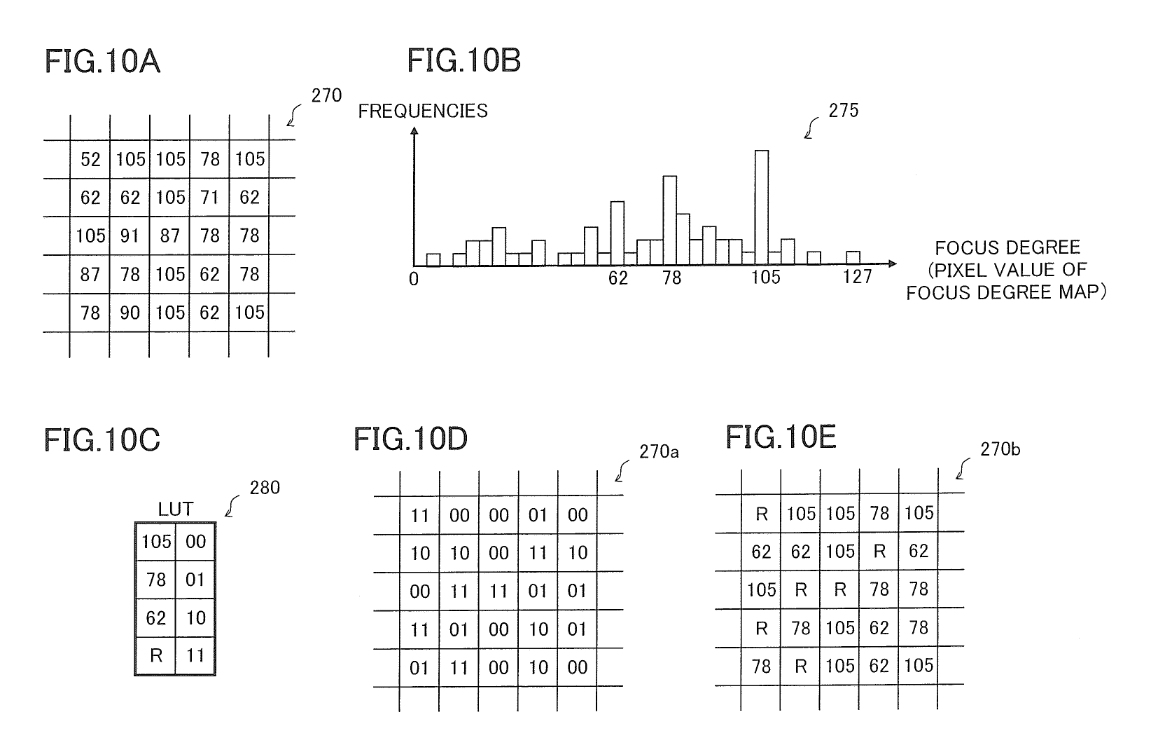

A specific method will be described. It is now assumed that the number of gradation levels of the basic focus degree map is 128 as described above. The basic focus degree map refers to the focus degree map before being embedded in the record target image. Each pixel signal of the basic focus degree map is any integer value that is equal to or more than 0 but equal to or less than 127. Reference numeral 270 shown in FIG. 10A represents the basic focus degree map. FIG. 10A shows an example of the pixel values of the individual pixel positions of the focus degree map 270. The record control portion 54 produces a histogram of the pixel values of the focus degree map 270. Reference numeral 275 shown in FIG. 10B represents the produced histogram. The record control portion 54 extracts, from the histogram 275, pixel values having the first, second and third largest numbers of frequencies. In this example, the pixel values having the first, second and third largest numbers of frequencies are 105, 78 and 62, respectively.

The record control portion 54 regards pixel values 105, 78 and 62 as the main gradation levels, and produces a LUT (lookup table) 280 which is shown in FIG. 10C and in which pieces of two-bit digital data “00”, “01” and “10” are allocated to the pixel values 105, 78 and 62, respectively. In the LUT 280, a piece of two-bit digital data “11” is allocated to a pixel value R. The pixel value R may be a predetermined fixed value (for example, 0 or 64); pixel values other than the pixel values 105, 78 and 62 may be extracted from the focus degree map 270, and the average value of the extracted pixel values may be used as the pixel value R.

Reference numeral 270a shown in FIG. 10D represents a focus degree map obtained by reducing the number of gradation levels of the focus degree map 270 to 2² with the LUT 280. The record control portion 54 uses the first embedding method to embed the focus degree map 270a in the record target image. In other words, the pixel signal of each pixel position of the focus degree map 270a is embedded in the lower-order two bits of each pixel signal of the record target image. Then, the record target image in which the focus degree map 270a is embedded is recorded in the recording medium 16. Here, LUT information that is information on the LUT 280 is also recorded in the additional region of the image file of the record target image.

The digital focus portion 50 reads, as necessary, the lower-order two bits of each pixel signal of the record target image from the image file of the record target image, and thereby can obtain the focus degree map 270a; the digital focus portion 50 uses the LUT information within the image file of the record target image, and thereby can generate a focus degree map 270b shown in FIG. 10E from the focus degree map 270a. The focus degree map 270b corresponds to a focus degree map obtained by replacing, with the pixel value R, all pixel values other than the pixel values 105, 78 and 62 of the focus degree map 270 shown in FIG. 10A. The output image generation portion 53 uses the focus degree map 270b, and thereby can perform the output image generation processing. Since information on the main gradation levels of the focus degree map 270 is left in the focus degree map 270b, even with the focus degree map 270b, it is possible to obtain an output image that is substantially equivalent to an output image obtained by using the focus degree map 270.

The values described above can be changed variously. In general, in the third embedding method, the following embedding is performed. When the number of gradation levels of the basic focus degree map is more than 2^{N}, the number of gradation levels of the basic focus degree map is reduced to 2^{N}, and thus the focus degree map having 2^{N} gradation levels is produced along with the corresponding LUT information, and the pixel signal of each pixel position of the focus degree map having 2^{N} gradation levels is embedded in the lower-order O bits of each pixel signal of the record target image (where N and O are natural numbers, and N≦O is satisfied). After the image file of the record target image is kept, the digital focus portion 50 reads, as necessary, the lower-order O bits of each pixel signal of the record target image and the LUT information from the image file of the record target image, and thus it is possible to obtain the focus degree map having 2^{N} gradation levels. The second and third embedding methods can be combined together. In other words, when the resolution of the focus degree map is smaller than that of the record target image, the second embedding method can be combined with the third embedding method, and they can also be utilized.

—Fourth Focus Degree Map Recording Method—

The fourth focus degree map recording method will be described. The focus degree map can be embedded in the thumbnail image of the record target image. In the fourth focus degree map recording method, the focus degree map is embedded in the thumbnail image of the record target image using an electronic watermark, and the thumbnail image in which the focus degree map is embedded is kept in the additional region of the image file. In other words, the thumbnail image is recorded, along with the record target image, in the recording medium 16 with the focus degree map embedded in the thumbnail image of the record target image using the electronic water mark. The embedding method is the same as the third focus degree map recording method.

Since the thumbnail image of the record target image is recorded such that it is associated with the record target image, in the fourth focus degree map recording method, the record target image and the focus degree map are associated with each other. In other words, the record target image and the focus degree map are recorded in the recording medium 16 with the record target image and the focus degree map associated with each other. As in the method of reading the focus degree map from the record target image embedded in the focus degree map, the focus degree map is read from the thumbnail image in which the focus degree map is embedded, and thus it is possible to obtain the focus degree map from the recording medium 16.

### Third Embodiment

The third embodiment of the present invention will be described. In the third embodiment, applied technologies that the image sensing device 1 can realize will be described. Unless a contradiction arises, it is possible to combine and practice a plurality of applied technologies among first to fifth applied technologies below.

—First Applied Technology—

The first applied technology will be described. Reference is made to FIGS. 11A and 11B. An original input image 230 and an output image 231 shown in FIG. 11A are the same as those shown in FIG. 6A or 6B. As described previously, the output image generation portion 53 can generate the output image 231 from the original input image 230, with the output image generation processing using either the focus degree map output from the focus degree map generation portion 51 or the focus degree map edition portion 52 or the focus degree map read from the recording medium 16. Moreover, the output image 231 can be input again to the output image generation portion 53 as the input image. The input image that is input to the output image generation portion 53 and that has been subjected to the output image generation processing one or more times is particularly referred to as a re-input image. When the output image 231 is input to the output image generation portion 53 as the input image, the output image 231 is referred to as the re-input image 231 (see FIG. 11B).

The user can provide an instruction to perform the output image generation processing on the re-input image 231; when such an instruction is provided, the output image generation portion 53 performs, on the re-input image 231, the output image generation processing using the focus degree map read from the image file of the output image 231, and thereby generates a new output image 232 (see FIG. 11B). When the output image 232 is generated, if the user provides the edition instruction, the focus degree map read from the image file of the output image 231 is edited by the focus degree map edition portion 52 according to the edition instruction, and the edited focus degree map is used in the output image generation processing for production of the output image 232. Furthermore, the output image 232 can be input to the output image generation portion 53 as the re-input image.

Incidentally, the focus degree map by the focus degree map generation portion 51 is generated on the assumption that the focus degree map is originally applied to the original input image. Hence, if the output image generation processing is performed again on the image on which the output image generation processing has been performed one or more times, the desired output image is not necessarily obtained. In particular, when the output image generation processing includes image restore processing for restoring image degradation, even if the output image generation processing is performed on the re-input image, the restore is not successfully performed, with the result that an output image different from the intended output image may be generated.

The user can display the original input image 230 or the output image 231 on the display portion 15, and can provide, as necessary, an instruction to perform the output image generation processing on the display image. However, without any improvement, even when the display image is the output image 231, the user may erroneously regard it as the original input image 230 to provide the above instruction on the display image.

In view of the foregoing, when the record control portion 54 records the record target image in the recording medium 16, the record control portion 54 associates, with the record target image, processing performance information indicating whether or not the record target image is an image obtained by performing the output image generation processing, and records it in the recording medium 16. Specifically, for example, as shown in FIG. 12A, when the record target image is kept in the image file, the processing performance information is preferably kept in the additional region of the image file of the record target image. The processing performance information is also said to be information indicating whether or not the record target image is the original input image. As shown in FIG. 12B, when the record target image is the original input image, a digital value “0” indicating “the record target image is not an image obtained by performing the output image generation processing” is written into the processing performance information; when the record target image is not the original input image (for example, when the record target image is the output image 231 or 232), a digital value “1” indicating “the record target image is an image obtained by performing the output image generation processing” is written into the processing performance information.

When the digital focus portion 50 reads the record target image from the recording medium 16, the digital focus portion 50 also reads the corresponding processing performance information. Then, when the display control portion 55 displays, on the display portion 15, the record target image read from the recording medium 16, the display control portion 55 also preferably displays a processing performance index based on the read processing performance information on the display portion 15. The processing performance index is an index for making the user recognize whether or not the display image is the original input image. For example, when the processing performance information on the record target image displayed on the display portion 15 is “1”, an icon indicating that the output image generation processing has been performed is displayed along with the record target image. On the other hand, when the processing performance information on the record target image displayed on the display portion 15 is “0”, the icon is not displayed or an icon different from such an icon is displayed along with the record target image.

When the user provides an instruction to perform the output image generation processing on the record target image kept in the recording medium 16, if the processing performance information on the record target image is “1”, the digital focus portion 50 may issue a warning indicating such a fact to the user. Any warning issuing method may be used. For example, the warning can be issued by displaying an image on the display portion 15 or by outputting sound with an unillustrated speaker (the same is true for a case, which will be described later, where a warning is issued).

—Second Applied Technology—

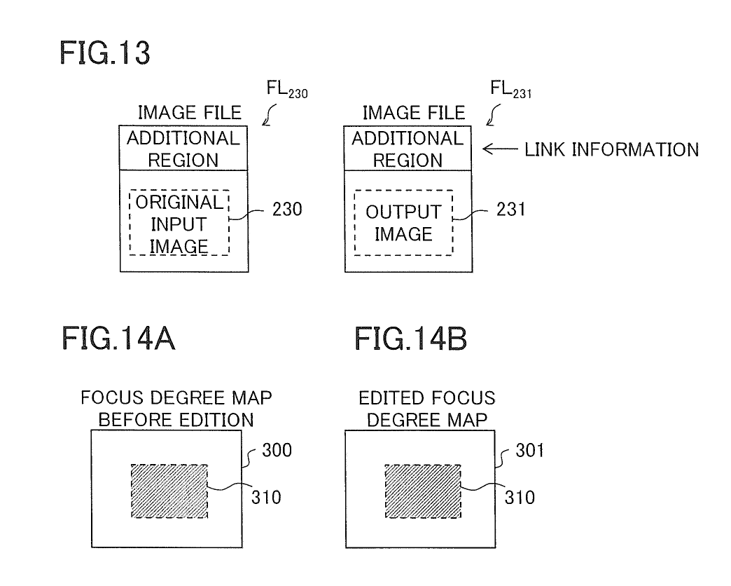

The second applied technology will be described. Reference is made to FIG. 11A and FIG. 13. When the output image 231 is generated from the original input image 230, the record control portion 54 can keep, in the recording medium 16, an image file FL₂₃₀ storing the original input image 230 and an image file FL₂₃₁ storing the output image 231. Here, the record control portion 54 keeps link information on the image file FL₂₃₀ in the additional region of the image file FL₂₃₁. Furthermore, the record control portion 54 keeps the focus degree map used for generation of the output image 231 from the original input image 230 in the additional region of the image file FL₂₃₁ or keeps such a focus degree map in the image file FL₂₃₁ with such a focus degree map embedded in the output image 231.

Unique information (for example, a file number) for the image file is given to each of the image files; the digital focus portion 50 references the unique information and thereby can specify the image file corresponding to the unique information. The link information on the image file FL₂₃₀ is the unique information of the image file FL₂₃₀ (for example, the file number of the image file FL₂₃₀); the digital focus portion 50 references the link information on the image file FL₂₃₀, and thereby can recognize in which record region on the recording medium 16 the image file FL₂₃₀ is present.

In the second applied technology, when the user provides an instruction to perform the output image generation processing on the output image 231 within the image file FL₂₃₁, the following operation is performed.

The digital focus portion 50 (for example, the output image generation portion 53) reads, from the image file FL₂₃₁, the focus degree map and the link information on the image file FL₂₃₀, uses the read link information to recognize the image file FL₂₃₀ on the recording medium 16 and reads the original input image 230 from the image file FL₂₃₀. The user provides, as appropriate, the edition instruction to edit a focus degree map MAP₂₃₁ read from the image file FL₂₃₁ to edit it, and thereby generates a focus degree map MAP₂₃₁′ that is the edited focus degree map. The output image generation portion 53 performs the output image generation processing based on the focus degree map MAP₂₃₁′ on the original input image 230 read from the image file FL₂₃₀, and thereby generates a new output image 231′ (unillustrated) separate from the output image 231. When the output image 231′ is generated, if the focus degree map MAP₂₃₁ is used instead of the focus degree map MAP₂₃₁′, the output image 231′ becomes the same as the output image 231. As described above, the output image generation processing is performed on the original input image, and thus an output image different from the intended output image is prevented from being generated, with the result that the problem described previously is avoided.

Even when the recording medium 16 is searched for the image file FL₂₃₀ using the link information on the image file FL₂₃₀, the image file FL₂₃₀ may not be found. For example, when the image file FL₂₃₀ is deleted from the recording medium 16 after the link information is generated, it is impossible to find the image file FL₂₃₀ from the recording medium 16. In this case, a warning about the fact that the original input image cannot be found may be issued to the user.

When the link information on the image file FL₂₃₀ is the file number of the image file FL₂₃₀, if the file number of the image file FL₂₃₀ is changed by the user after the link information is kept, the image file FL₂₃₀ cannot be identified with the link information. It is therefore preferable to give the image file FL₂₃₀ fixed unique information that the user cannot change and to keep the fixed unique information in the image file FL₂₃₁ as the link information on the image file FL₂₃₀.

—Third Applied Technology—

The third applied technology will be described. As described above, it is possible to keep, in the recording medium 16, the edited focus degree map generated based on the edition instruction provided by the user, either instead of the focus degree map before edition or in addition to the focus degree map before edition. When the edited focus degree map is discarded, since it is difficult to reproduce exactly the same focus degree map, the edited focus degree map is preferably kept. However, when the edited focus degree map is kept, this increases the size of the image file.

In order for this increase to be minimized, when the edited focus degree map is kept, only part of the edited focus degree map that the user has changed through the edition instruction may be kept. In other words, when reference numerals 300 and 301 shown in FIGS. 14A and 14B represent the focus degree map before edition and the edited focus degree map, respectively, and the edition instruction to change the focus degree (pixel value) of only a region 310 that is part of the entire region of the focus degree map 300 is provided, only the focus degree (focus degree resulting from the changing) of the region 310 of the focus degree map 301 may be kept in the corresponding image file. This is because, when at least the focus degree of the region 310 of the focus degree map 301 is kept, it is possible to reproduce the entire focus degree map 301 using the focus degree map 300.

A difference between the focus degree map 301 storing only the focus degree of the region 310 and the focus degree map 300 is determined, and thus the focus degree (pixel value) of the part that has not been changed through the edition instruction becomes zero, with the result that an image compression ratio is increased and the file size is decreased. The focus degree map 301 storing only the focus degree of the region 310 may be kept in the second thumbnail record region. Here, when the region 310 is set at the noted region, and only the focus degree (pixel value) within the region 310 is kept, it is possible to reduce the increase in the file size.

—Fourth Applied Technology—

The fourth applied technology will be described. A time stamp indicating a time when the record target image is generated is included in the additional information of each image file. The time stamp of the original input image 230 indicates a time when the original input image 230 is shot. The time stamp of the output image 231 can be assumed to be a time when the output image 231 is generated. However, if so, the time stamps of the original input image 230 and the output image 231 do not agree with each other (however, the automatic focus degree adjustment function described with reference to FIG. 6B is assumed to be invalid), and, when the user references the image file FL₂₃₁ of the output image 231, the user has difficulty recognizing which image file is the image file FL₂₃₀ that is the original file of the output image 231.

In view of the foregoing, when the image file FL₂₃₁ is generated, the time stamp of the image file FL₂₃₁ may be made to agree with the time stamp of the image file FL₂₃₀ regardless of the time when the output image 231 is generated. The same is true for the time stamp of the image file of the output image (for example, the output image 232 shown in FIG. 11B) based on the re-input image.

—Fifth Applied Technology—

The fifth applied technology will be described. Camera information is included in the additional information of each image file. The camera information includes the shooting conditions of the record target image, such as an aperture value and a focal length when the record target image is shot. When the output image 231 is generated, the camera information on the image file FL₂₃₁ of the output image 231 can be made the same as the camera information on the image file FL₂₃₀ of the original input image 230. The same is true for the camera information on the image file of the output image (for example, the output image 232 of FIG. 11B) based on the re-input image.

On the other hand, the depth of field and the like of an image can be changed by the output image generation processing (which will be described in detail later). For example, the depth of field of the output image 231 may be made shallower than that of the original input image 230 by the output image generation processing. In this case, when the camera information is the same between the image file FL₂₃₀ and the image file FL₂₃₁, it is difficult to search for the image file based on the camera information. Specifically, for example, even when, in order for a large number of image files within the recording medium 16 to be searched for the image file FL₂₃₁ storing the output image 231 with a relatively shallow depth of field, the search condition is set at an “image with a relatively shallow depth of field” and then the search is performed, if the camera information on the image file FL₂₃₁ is the same as that on the original input image 230 with a relatively deep depth of field, it is impossible to find the image file FL₂₃₁ even when the above search is performed.

In view of the foregoing, the camera information kept in the image file FL₂₃₁ may be changed from the camera information kept in the image file FL₂₃₀ according to the details of the output image generation processing. The same is true for the camera information on the image file of the output image (for example, the output image 232 of FIG. 11B) based on the re-input image.

### Fourth Embodiment

A fourth embodiment will be described. In the fourth embodiment, as a method of performing the output image generation processing that can be employed in the output image generation portion 53 of FIG. 4, first to sixth image processing methods will be described by way of example.

—First Image Processing Method—

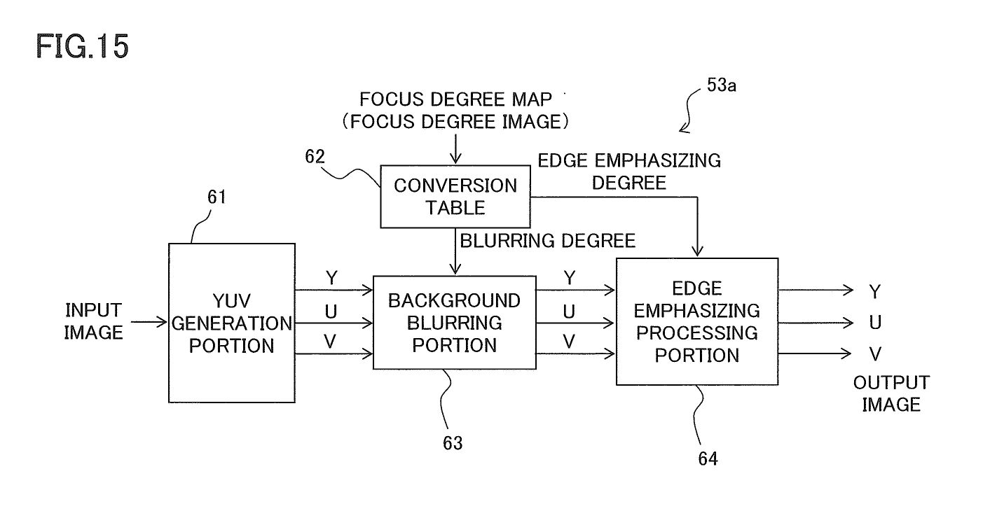

The first image processing method will be described. FIG. 15 shows an internal block diagram of an output image generation portion 53a that can be employed in the output image generation portion 53 of FIG. 4. The output image generation portion 53a includes portions represented by reference numerals 61 to 64. The YUV generation portion 61 may be provided within the main control portion 13 of FIG. 1. The YUV generation portion 61 may be provided outside the output image generation portion 53a.

The YUV generation portion 61 changes the format of the image signal of the input image from a RAW data format to a YUV format. Specifically, the YUV generation portion 61 generates the brightness signal and the color-difference signal of the input image from the RAW data on the input image. Hereinafter, the brightness signal is referred to as a Y signal, and two signal components constituting the color-difference signal are referred to as a U signal and a V signal.

The conversion table 62 determines and outputs, based on the focus degree map given thereto, for each pixel, a blurring degree and an edge emphasizing degree. The focus degree, the blurring degree and the edge emphasizing degree of the pixel (x, y) are represented by FD (x, y), BD (x, y) and ED (x, y), respectively.

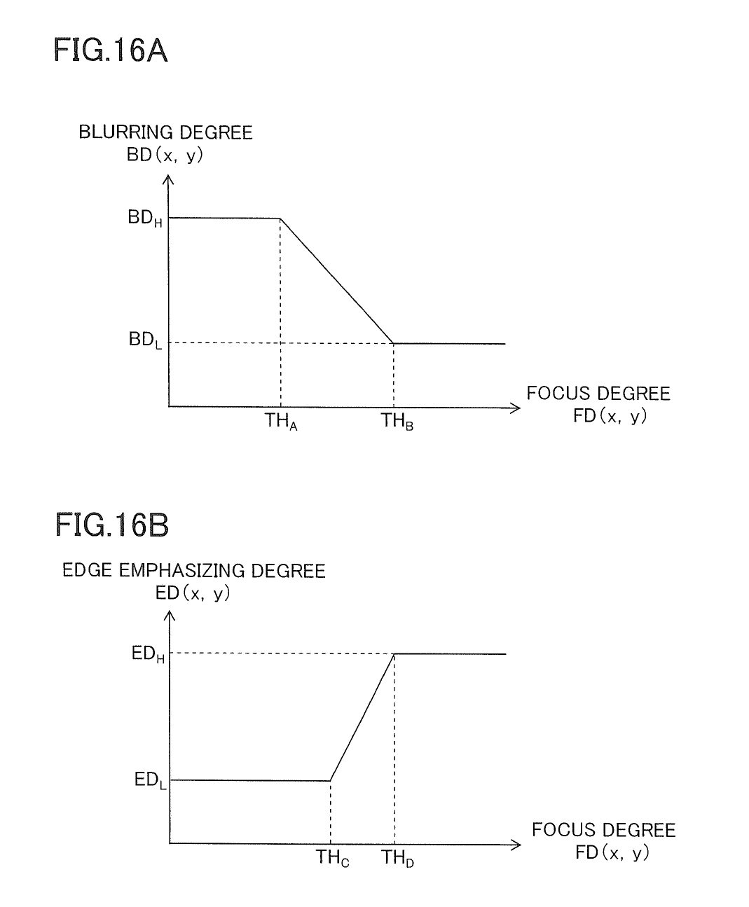

FIG. 16A shows a relationship between the focus degree that forms the focus degree map and the blurring degree. As shown in FIG. 16A, in the conversion table 62, when an inequality “FD (x, y)<TH_{A}” holds true, the blurring degree BD (x, y) is set at an upper limit blurring degree BD_{H}; when an inequality “TH_{A}≦FD (x, y)<TH_{B}” holds true, as the focus degree FD (x, y) is increased from the threshold value TH_{A} to the threshold value TH_{B}, the blurring degree BD (x, y) is linearly (or non-linearly) decreased from the upper limit blurring degree BD_{H} to a lower limit blurring degree BD_{L}; when an inequality “TH_{B}≦FD (x, y)” holds true, the blurring degree BD (x, y) is set at the lower limit blurring degree BD_{L}. Here, BD_{H}, BD_{L}, TH_{A} and TH_{B} can be previously set such that an inequality “0<BD_{L}<BD_{H}” and an inequality “0<TH_{A}<TH_{B}” are satisfied (for example, BD_{H}=7 and BD_{L}=1).

FIG. 16B shows a relationship between the focus degree that forms the focus degree map and the edge emphasizing degree. As shown in FIG. 16B, in the conversion table 62, when an inequality “FD (x, y)<TH_{C}” holds true, the edge emphasizing degree ED (x, y) is set at a lower limit edge emphasizing degree ED_{L}; when an inequality “TH_{C}≦FD (x, y)<TH_{D}” holds true, as the focus degree FD (x, y) is increased from the threshold value TH_{C} to the threshold value TH_{D}, the edge emphasizing degree ED (x, y) is linearly (or non-linearly) increased from the lower limit edge emphasizing degree ED_{L} to an upper limit edge emphasizing degree ED_{H}; when an inequality “TH_{D}≦FD (x, y)” holds true, the edge emphasizing degree ED (x, y) is set at the upper limit edge emphasizing degree ED_{H}. Here, ED_{H}, ED_{L}, TH_{C} and TH_{D} can be previously set such that an inequality “0<ED_{L}<ED_{H}” and an inequality “0<TH_{C}<TH_{D}” are satisfied.

The background blurring portion 63 of FIG. 15 performs blurring processing for each pixel on Y, U and V signals output from the YUV generation portion 61 according to the blurring degree of each pixel output from the conversion table 62. Preferably, on an image portion in which the blurring degree BD (x, y) agrees with the lower limit blurring degree BD_{L}, the blurring processing is not performed. The blurring processing may be performed either on each of the Y, U and V signals or on the Y signal alone. A spatial domain filtering using a spatial domain filter for smoothing the Y signal in a spatial domain is used, and thus it is possible to perform the blurring processing on the Y signal (the same is true for the U and V signals). As the spatial domain filter, an averaging filter, a weighted averaging filter, a Gaussian filter or the like can be used; the blurring degree can also be used as the dispersion of Gaussian distribution in the Gaussian filter. A frequency domain filtering using a low-pass filter for leaving a low-frequency component and removing a high-frequency component among spatial frequency components included in the Y signal may be used, and thus it is possible to perform the blurring processing on the Y signal (the same is true for the U and V signals).

As the focus degree FD (x, y) of the noted pixel (x, y) becomes smaller and thus the blurring degree BD (x, y) of the noted pixel (x, y) becomes larger, the blurring degree (the magnitude of blurring) of an image portion composed of the noted pixel (x, y) and adjacent pixels of the noted pixel (x, y) is increased. The averaging filter is assumed to be used in the blurring processing, and a simple example is taken. For example, when the blurring degree BD (x, y) is larger than the lower limit blurring degree BD_{L} but is smaller the upper limit blurring degree BD_{H}, the blurring processing is performed on the noted pixel (x, y) using the averaging filter having a 3×3 filter size whereas when the blurring degree BD (x, y) is equal to the upper limit blurring degree BD_{H}, the blurring processing is performed on the noted pixel (x, y) using the averaging filter having a 5×5 filter size. In this way, as the blurring degree BD (x, y) becomes larger, the blurring degree (the magnitude of blurring) of the corresponding portion becomes larger.

The edge emphasizing processing portion 64 of FIG. 15 performs edge emphasizing processing for each pixel on the Y, U and V signals which are output from the background blurring portion 63 and on which the blurring processing has been performed. The edge emphasizing processing is processing that uses a sharpness filter such as a Laplacian filter and that emphasizes the edges of an image. Preferably, the filter coefficient of the sharpness filter is variably set according to the edge emphasizing degree ED (x, y) such that, as the edge emphasizing degree ED (x, y) of the noted pixel (x, y) is increased, the edge emphasizing degree (the magnitude of edge emphasizing) of an image portion composed of the noted pixel (x, y) and adjacent pixels of the noted pixel (x, y) is increased.

The Y, U and V signals on which the edge emphasizing processing portion 64 has performed the edge emphasizing processing are generated as the Y, U and V signals of the output image. It is possible to omit the edge emphasizing processing portion 64; in this case, the Y, U and V signals which are output from the background blurring portion 63 and on which the blurring processing has been performed function as the Y, U and V signals of the output image.

The blurring processing described above is included in the output image generation processing, and thus it is possible to obtain the output image 211 (see FIG. 5B) having a “blurring effect” in which a background subject (building SUB₃) is blurred and the main subject (the flower SUB₁ or the person SUB₂) appears to stand out. In other words, it is possible to obtain an output image in which the subject of an image portion having a relatively large focus degree is enhanced more visually than the subject of an image portion having a relatively small focus degree (the same enhancement effect is achieved by the second to fourth image processing methods, which will be described later).

—Second Image Processing Method—

The second image processing method will be described. In the second image processing method, the blurring processing performed by the background blurring portion 63 of FIG. 15 is replaced by brightness reduction processing. The first image processing method and the second image processing method are the same except for this replacement.

In the second image processing method, the background blurring portion 63 of FIG. 15 performs the brightness reduction processing for each pixel on the Y signal output from the YUV generation portion 61 according to the blurring degree of each pixel output from the conversion table 62. Preferably, on an image portion in which the blurring degree BD (x, y) agrees with the lower limit blurring degree BD_{L}, the brightness reduction processing is not performed.

In the brightness reduction processing, as the focus degree FD (x, y) of the noted pixel (x, y) becomes smaller and thus the blurring degree BD (x, y) of the noted pixel (x, y) becomes larger, the level of the Y signal of the noted pixel (x, y) is more significantly reduced. It is assumed that, as the level of the Y signal of the noted pixel (x, y) is reduced, the brightness of the noted pixel (x, y) is decreased. The brightness reduction processing described above is included in the output image generation processing, and thus it is possible to generate an output image in which the background subject (building SUB₃) is darkened and the main subject (the flower SUB₁ or the person SUB₂) is enhanced to appear to stand out.

—Third Image Processing Method—

The third image processing method will be described. In the third image processing method, the blurring processing performed by the background blurring portion 63 of FIG. 15 is replaced by chroma reduction processing. The first image processing method and the third image processing method are the same except for this replacement.

In the third image processing method, the background blurring portion 63 of FIG. 15 performs the chroma reduction processing for each pixel on the U and V signals output from the YUV generation portion 61 according to the blurring degree of each pixel output from the conversion table 62. Preferably, on the image portion in which the blurring degree BD (x, y) agrees with the lower limit blurring degree BD_{L}, the chroma reduction processing is not performed.

In the chroma reduction processing, as the focus degree FD (x, y) of the noted pixel (x, y) becomes smaller and thus the blurring degree BD (x, y) of the noted pixel (x, y) becomes larger, the levels of the U and V signals of the noted pixel (x, y) are more significantly reduced. It is assumed that, as the levels of the U and V signals of the noted pixel (x, y) are reduced, the chroma of the noted pixel (x, y) is decreased. The chroma reduction processing described above is included in the output image generation processing, and thus it is possible to generate an output image in which the chroma of the background subject (building SUB₃) is decreased and the main subject (the flower SUB₁ or the person SUB₂) is enhanced to appear to stand out.

Two or more types of processing among the blurring processing, the brightness reduction processing and the chroma reduction processing described above may be performed by the background blurring portion 63 of FIG. 15.

—Fourth Image Processing Method—

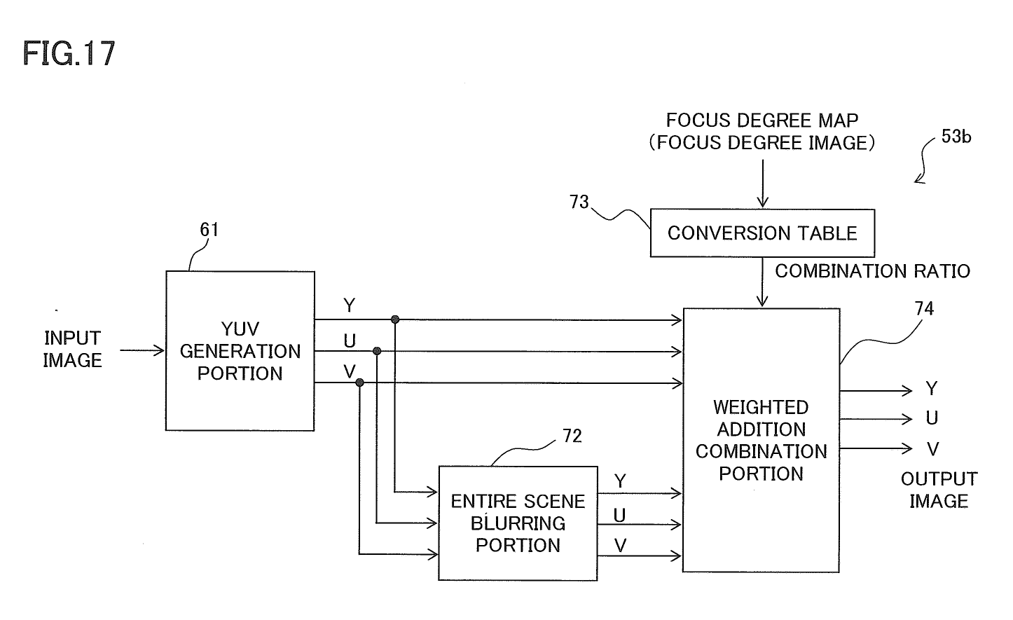

The fourth image processing method will be described. FIG. 17 shows, in the fourth image processing method, an internal block diagram of an output image generation portion 53b that can be employed in the output image generation portion 53 of FIG. 4. The output image generation portion 53b includes portions represented by reference numerals 61 and 72 to 74. The YUV generation portion 61 may be provided within the main control portion 13 of FIG. 1. The YUV generation portion 61 may be provided outside the output image generation portion 53b. The YUV generation portion 61 of FIG. 17 is the same as that shown in FIG. 15.

The entire scene blurring portion 72 evenly performs the blurring processing on the image signal output from the YUV generation portion 61. The blurring processing performed by the entire scene blurring portion 72 is referred to as entire scene blurring processing so that it is distinguished from the blurring processing in the first image processing method. In the entire scene blurring processing, the entire input image is blurred under common conditions regardless of the focus degree map. The entire scene blurring processing may be performed either on each of the Y, U and V signals or on the Y signal alone. The spatial domain filtering using the spatial domain filter for smoothing the Y signal in the spatial domain is used, and thus it is possible to perform the entire scene blurring processing on the Y signal (the same is true for the U and V signals). As the spatial domain filter, an averaging filter, a weighted averaging filter, a Gaussian filter or the like can be used. The frequency domain filtering using the low-pass filter for leaving a low-frequency component and removing a high-frequency component among spatial frequency components included in the Y signal may be used, and thus it is possible to perform the entire scene blurring processing on the Y signal (the same is true for the U and V signals).

The entire scene blurring portion 72 outputs the Y, U and V signals on which the entire scene blurring processing has been performed to the weighted addition combination portion 74. An image that has, as the image signals, the Y, U and V signals on which the entire scene blurring processing has been performed, that is, the input image on which the entire scene blurring processing has been performed is referred to as an entire scene blurred image.

The conversion table 73 determines and outputs, based on the focus degree map given thereto, for each pixel, a combination ratio (in other words, a mixing ratio) between the input image and the entire scene blurred image. As described previously, the focus degree of the pixel (x, y) is represented by FD (x, y), and the combination ratio for the pixel (x, y) is represented by K (x, y).

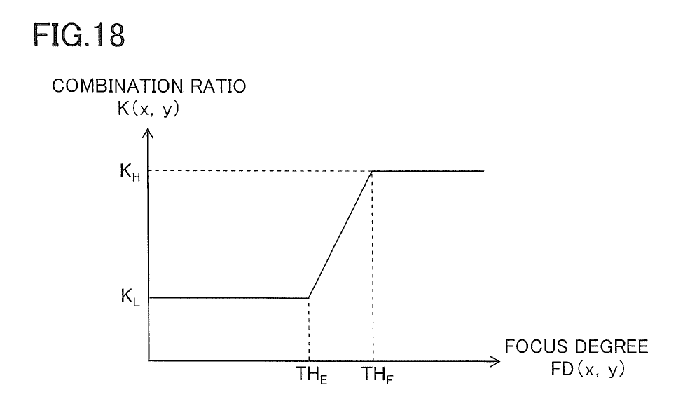

FIG. 18 shows a relationship between the focus degree that forms the focus degree map and the combination ratio. As shown in FIG. 18, in the conversion table 73, when an inequality “FD (x, y)<TH_{E}” holds true, the combination ratio K (x, y) is set at a lower limit ratio K_{L}; when an inequality “TH_{E}≦FD (x, y)<TH_{F}” holds true, as the focus degree FD (x, y) is increased from the threshold value TH_{E} to the threshold value TH_{F}, the combination ratio K (x, y) is linearly (or non-linearly) increased from the lower limit ratio K_{L} to an upper limit ratio K_{H}; when an inequality “TH_{F}≦FD (x, y)” holds true, the combination ratio K (x, y) is set at the upper limit ratio K_{H}. Here, K_{H}, K_{L}, TH_{E} and TH_{F} can be previously set such that an inequality “0≦K_{L}<K_{H}≦1” and an inequality “0<TH_{E}<TH_{F}” are satisfied. In general, K_{L}=0 and K_{H}=1.

The weighted addition combination portion 74 combines the input image and the entire scene blurred image such that the image signal of the input image and the image signal of the entire scene blurred image are mixed for each pixel according to the combination ratio (the mixing ratio) output from the conversion table 73. The combination image thus obtained is the output image obtained by the fourth image processing method. Naturally, the mixing of the image signals is performed on each of the Y, U and V signals. Specifically, when the Y signal of the pixel (x, y) of the input image, the Y signal of the pixel (x, y) of the entire scene blurred image and the Y signal of the pixel (x, y) of the output image are represented by Y1 (x, y), Y2 (x, y) and Y3 (x, y), respectively, Y3 (x, y) is generated according to the following equation (the U and V signals of the output image are generated in the same manner):

Y3 (x, y)=K (x, y)·Y1 (x, y)+(1−K (x, y))·Y2 (x, y)

In an image portion having a relatively large focus degree, the contribution of the input image to the output image is increased whereas, in an image portion having a relatively small focus degree, the contribution of the entire scene blurred image to the output image is increased. Hence, the entire scene blurring processing and the image combination processing described above are included in the output image generation processing, and thus, in the process of generating the output image from the input image, an image portion having a relatively small focus degree is blurred more than an image portion having a relatively large focus degree. Consequently, it is possible to obtain the output image 211 (see FIG. 5B) having a “blurring effect” in which the background subject (building SUB₃) is blurred and the main subject (the flower SUB₁ or the person SUB₂) appears to stand out.

As the first image processing method is changed to the second image processing method, the entire scene blurring portion 72 may perform, on the input image, entire scene brightness reduction processing instead of the entire scene blurring processing. In the entire scene brightness reduction processing, the levels of the Y signals of all the pixels of the input image are reduced under common conditions regardless of the focus degree map. The Y signal after this reduction and the Y signal of the input image itself are mixed, as described above, for each pixel, according to the combination ratio, and thus it is possible to obtain the Y signal of the output image (in this case, the U and V signals of the output image are made the same as the U and V signals of the input image). When the entire scene brightness reduction processing is performed, in the process of generating the output image from the input image, the brightness of an image portion having a relatively small focus degree is reduced more than that of an image portion having a relatively large focus degree.

As the first image processing method is changed to the third image processing method, the entire scene blurring portion 72 may perform, on the input image, entire scene chroma reduction processing instead of the entire scene blurring processing. In the entire scene chroma reduction processing, the levels of the U and V signals of all the pixels of the input image are reduced under common conditions regardless of the focus degree map. The U and V signals after this reduction and the U and V signals of the input image itself are mixed, as described above, for each pixel, according to the combination ratio, and thus it is possible to obtain the U and V signals of the output image (in this case, the Y signal of the output image is made the same as the Y signal of the input image). When the entire scene chroma reduction processing is performed, in the process of generating the output image from the input image, the chroma of an image portion having a relatively small focus degree is reduced more than that of an image portion having a relatively large chroma. Two or more types of processing among the entire scene blurring processing, the entire scene brightness reduction processing and the entire scene chroma reduction processing described above may be performed by the entire scene blurring portion 72 of FIG. 17.

—Fifth Image Processing Method—

The fifth image processing method will be described. With the first to fourth image processing methods described above, it is possible to obtain the effect of making the depth of field of the output image shallower than that of the input image. However, with any one of the first to fourth image processing methods described above, it is difficult to make the depth of field of the output image deeper than that of the input image.

However, when the image restore processing for restoring degradation resulting from the burring of an image is included in the output image generation processing, it is possible to make the depth of field of the output image deeper than that of the input image either in part of the image or in the entire image. For example, the blurring of the input image is regarded as degradation, and the image restore processing (in other words, image restoring processing for removing the degradation) for restoring the degradation is performed on the input image, and thus it is also possible to generate an overall focus degree image. The overall focus degree image refers to an image in which the overall image is in focus. The image restore processing for generating the overall focus degree image is included in the output image generation processing, and furthermore, any one of the first to fourth image processing methods is used, and thus it is possible to generate an output image having arbitrary depth of field and focus distance. As the image restore processing described above, a known method can be utilized.

—Sixth Image Processing Method—

The sixth image processing method will be described. In the sixth image processing method, a method (hereinafter referred to as a light field method) called “light field photography” is used, and thus an output image having arbitrary depth of field and focus distance is generated from an input image based on the output signal of the image sensor 33. As the method of generating an image having arbitrary depth of field and focus distance based on the output signal of the image sensor 33, a known method (for example, a method disclosed in WO 06/039486 or JP-A-2009-224982) based on the light field method can be utilized. In the light field method, an image sensing lens having an aperture stop and a microlens array are used, and thus an image signal obtained from the image sensor includes not only the intensity distribution of light on the light receiving surface of the image sensor but also information on the direction in which the light travels. The image sensing device employing the light field method performs image processing based on an image signal from the image sensor, and thereby can restructure an image having arbitrary depth of field and focus distance. In other words, with the light field method, it is possible to freely structure, after the image is shot, an output image in which an arbitrary subject is in focus.

Hence, although not shown in FIG. 2, when the light field method is used, optical members necessary to realize the light field method are provided in the image sensing portion 11 (the same is true for a fifth embodiment, which will be described later). These optical members include the microlens array; incident light from the subject enters the light receiving surface (in other words, the image sensing surface) of the image sensor 33 through the microlens array and the like. The microlens array is composed of a plurality of microlenses; one microlens is allocated to one or a plurality of light receiving pixels on the image sensor 33. Hence, the output signal of the image sensor 33 includes not only the intensity distribution of light on the light receiving surface of the image sensor 33 but also information on the direction in which the light enters the image sensor 33.

The output image generation portion 53 recognizes, from the focus degree map given thereto, the degree of focusing in each position on the output image, performs, on the input image, with the focus degree map, image processing using the light field method as the output image generation processing and thereby generates the output image. Simply, for example, in the case where the entire region of the focus degree map is composed of first and second regions, and where the focus degree of the first region is sufficiently high and the focus degree of the second region is sufficiently low, the image processing using the light field method is performed such that only an image within the first region on the output image is in focus and an image within the second region on the output image is blurred. When the light field method is used, an input image necessary to be given to the output image generation portion 53 is preferably the original input image based on the output signal of the image sensor 33. That is because the output signal of the image sensor 33 includes the information that is necessary to realize the light field method and that indicates the direction in which the incident light travels, and the information indicating the direction in the incident light travels may be degraded in the re-input image (see FIG. 11B).

### Fifth Embodiment

The fifth embodiment will be described. In the fifth embodiment, as a method of deriving the focus degree and a method of generating the focus degree map that can be employed in the focus degree map generation portion 51 of FIG. 4, first to sixth focus degree derivation methods will be described by way of example.

—First Focus Degree Derivation Method—

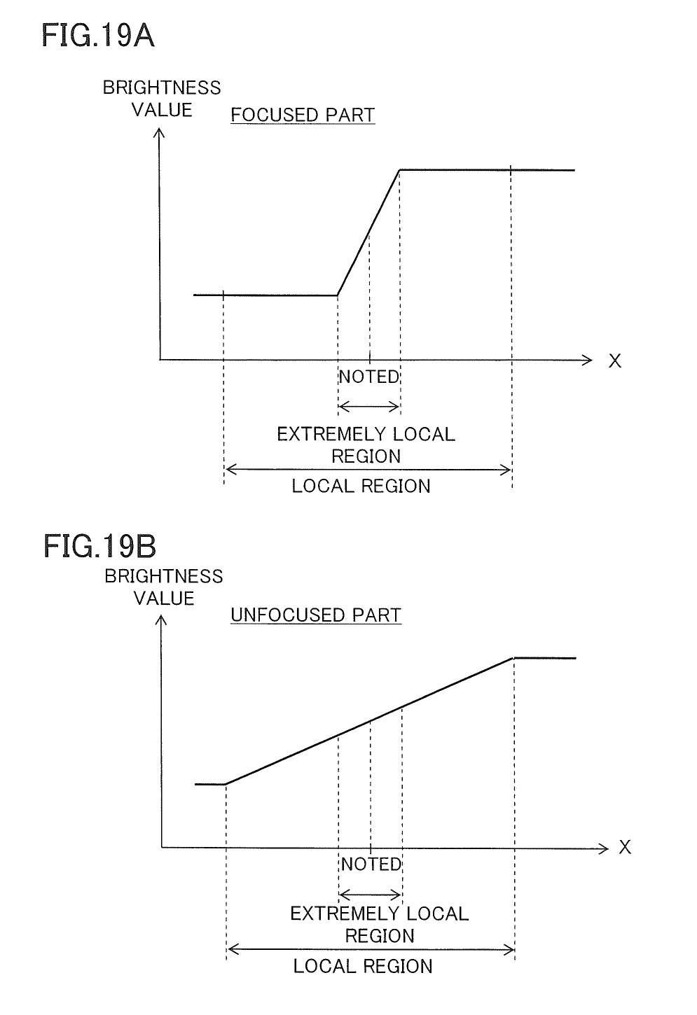

The first focus degree derivation method will be described. In the first focus degree derivation method and the second focus degree derivation method, which will be described later, the image signal of the input image (in particular, the original input image) is used as the focus degree derivation information (see FIG. 4). The principle of the first focus degree derivation method will be described while attention is being focused on one dimension alone. FIG. 19A shows a pattern of a typical brightness signal in a focused part on the input image; FIG. 19B shows a pattern of a typical brightness signal in an unfocused part on the input image. In the focused part and the unfocused part corresponding to FIGS. 19A and 19B, an edge that is a boundary portion of brightness change is assumed to be present. In each graph of FIGS. 19A and 19B, the horizontal axis represents an X axis, and the vertical axis represents a brightness value. The brightness value refers to the value of the brightness signal, and is synonymous with the level of the brightness signal (that is, the Y signal). As the brightness value of the noted pixel (x, y) is increased, the brightness of the noted pixel (x, y) is increased.

When, in the focused part of FIG. 19A, the center portion of the edge is regarded as the noted pixel (target pixel), and a difference (hereinafter, referred to as a brightness difference value of an extremely local region) between the maximum value and the minimum value of the brightness signal within an extremely local region (for example, a region having a width equivalent to the width of three pixels) in which the noted pixel is arranged in the center thereof and a difference (hereinafter, referred to as a brightness difference value of a local region) between the maximum value and the minimum value of the brightness signal within a local region (for example, a region having a width equivalent to the width of seven pixels) in which the noted pixel is arranged in the center thereof are determined, since the brightness is changed rapidly in the focused part, (the brightness difference value of the extremely local region)/(the brightness difference value of the local region) is substantially one.

By contrast, when, in the unfocused part of FIG. 19B, the center portion of the edge is regarded as the noted pixel (target pixel), and, as described above, a brightness difference value of an extremely local region in which the noted pixel is arranged in the center thereof and a brightness difference value of a local region in which the noted pixel is arranged in the center thereof are determined, since the brightness is changed slowly in the unfocused part, (the brightness difference value of the extremely local region)/(the brightness difference value of the local region) is significantly less than one.

In the first focus degree derivation method, the focus degree is derived utilizing a characteristic in which the ratio “(the brightness difference value of the extremely local region)/(the brightness difference value of the local region)” differs between the focused part and the unfocused part.

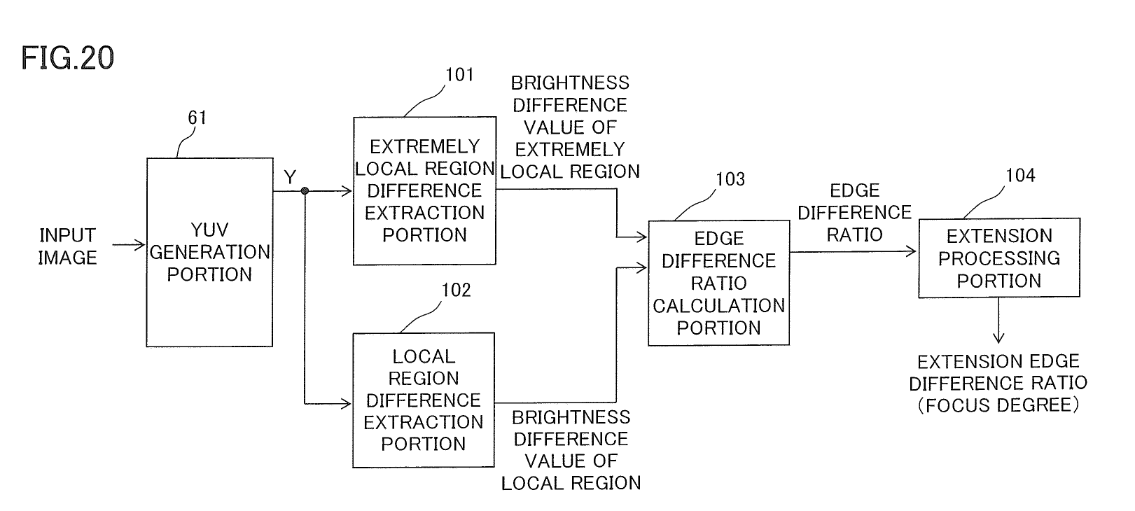

FIG. 20 is a block diagram of portions that derive the focus degree in the first focus degree derivation method. The YUV generation portion 61 of FIG. 20 is the same as shown in FIG. 15 or 17. The portions represented by reference numerals 101 to 104 in FIG. 20 can be provided in the focus degree map generation portion 51 of FIG. 4.

The Y signal of the input image output from the YUV generation portion 61 is sent to an extremely local region difference extraction portion 101 (hereinafter, may be briefly referred to as an extraction portion 101) and a local region difference extraction portion 102 (hereinafter, may be briefly referred to as an extraction portion 102). The extraction portion 101 extracts the brightness difference value of the extremely local region for each pixel from the Y signal of the input image and outputs it. The extraction portion 102 extracts the brightness difference value of the local region for each pixel from the Y signal of the input image and outputs it. An edge difference ratio calculation portion 103 (hereinafter, may be briefly referred to as a calculation portion 103) calculates and outputs, for each pixel, as an edge difference ratio, a ratio between the brightness difference value of the extremely local region and the brightness difference value of the local region or a value corresponding to the ratio.

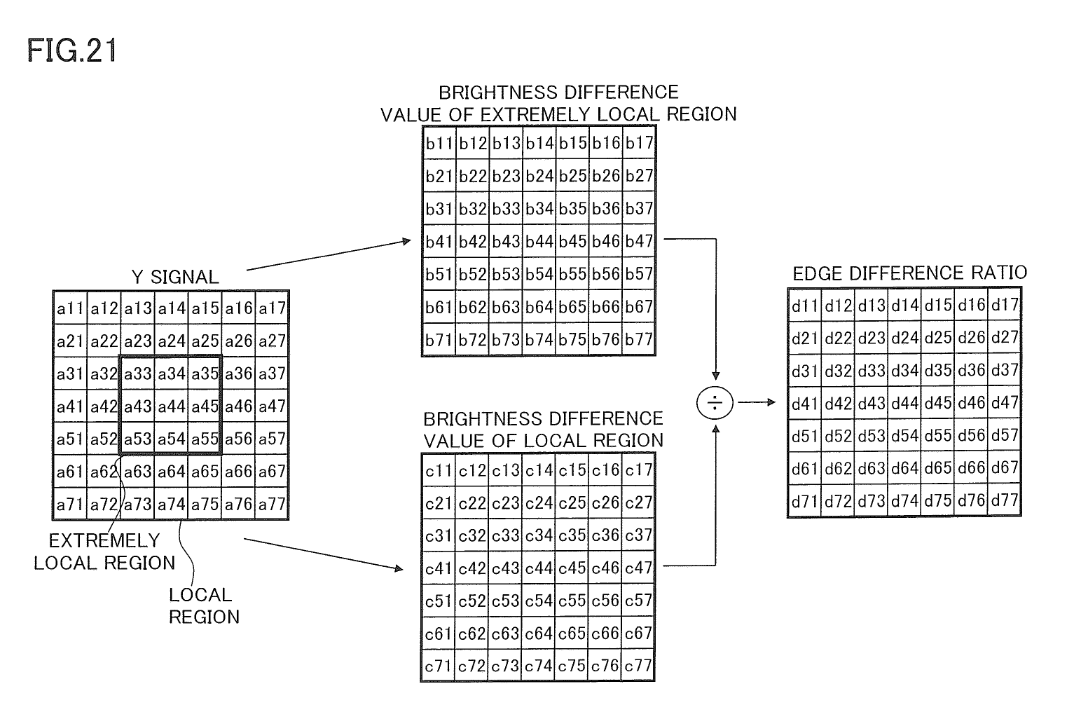

FIG. 21 is a diagram showing how the brightness difference value of the extremely local region, the brightness difference value of the local region and the edge difference ratio are determined from the Y signal of the input image. For ease of description, the calculation processing will be described while attention is focused on an image region of 7×7 pixels. The brightness value of the pixel (i, j) on the input image is represented by aij. Hence, for example, a12 represents the brightness value of a pixel (1, 2) on the input image. Here, i and j are integers and are also arbitrary variables that represent a horizontal coordinate value x and a vertical coordinate value y of a pixel. The brightness difference value of the extremely local region, the brightness difference value of the local region and the edge difference ratio that are determined for the pixel (i, j) are represented by bij, cij and dij, respectively. The extremely local region refers to a relatively small image region in which the noted pixel is arranged in the center thereof; the local region refers to an image region which is larger than the extremely local region and in which the noted pixel is arranged in the center thereof.

In FIG. 21, as an example, an image region of 3×3 pixels is defined as the extremely local region, and an image region of 7×7 pixels is defined as the local region. Hence, when the noted pixel is the pixel (4, 4), an image region formed with a total of 9 pixels (i, j) that satisfy 3≦i≦5 and 3≦j≦5 is the extremely local region of the noted pixel (4, 4), and an image region formed with a total of 49 pixels (i, j) that satisfy 1≦i≦7 and 1≦j≦7 is the local region of the noted pixel (4, 4).

The extremely local region difference extraction portion 101 calculates a difference between the maximum value and the minimum value of the brightness value of the extremely local region of the noted pixel as the brightness difference value of the extremely local region of the noted pixel. The calculation is performed such that the brightness difference value bij of the extremely local region is equal to or more than zero. For example, when a55 is the maximum value and a33 is the minimum value in the extremely local region of the noted pixel (4, 4), the brightness difference value b44 of the extremely local region of the noted pixel (4, 4) is determined by “b44=a55−a33.”

The local region difference extraction portion 102 calculates a difference between the maximum value and the minimum value of the brightness value of the local region of the noted pixel as the brightness difference value of the local region of the noted pixel. The calculation is performed such that the brightness difference value cij of the local region is equal to or more than zero. For example, when a11 is the maximum value and a17 is the minimum value in the local region of the noted pixel (4, 4), the brightness difference value c44 of the local region of the noted pixel (4, 4) is determined by “c44=a11−a17.”

The noted pixel is shifted in a horizontal or vertical direction on a pixel by pixel basis; each time the noted pixel is shifted, the brightness difference value of the extremely local region and the brightness difference value of the local region are calculated. Consequently, the brightness difference values of the extremely local regions and the brightness difference values of the local regions in all pixels are determined. In the example of FIG. 21, b11 to b77 and c11 to c77 are all determined.

The edge difference ratio calculation portion 103 calculates, as the edge difference ratio, for each pixel, a ratio of the brightness difference value of the extremely local region to a value obtained by adding a predetermined small value V_{OFFSET} to the brightness difference value of the local region. That is, the edge difference ratio dij for the pixel (i, j) is determined according to the equation “dij=bij/(cij+V_{OFFSET}).” As shown in FIG. 21, d11 to d77 are determined from b11 to b77 and c11 to c77. The V_{OFFSET} is an offset value that is set to prevent the denominator of the equation from becoming zero and that is positive.

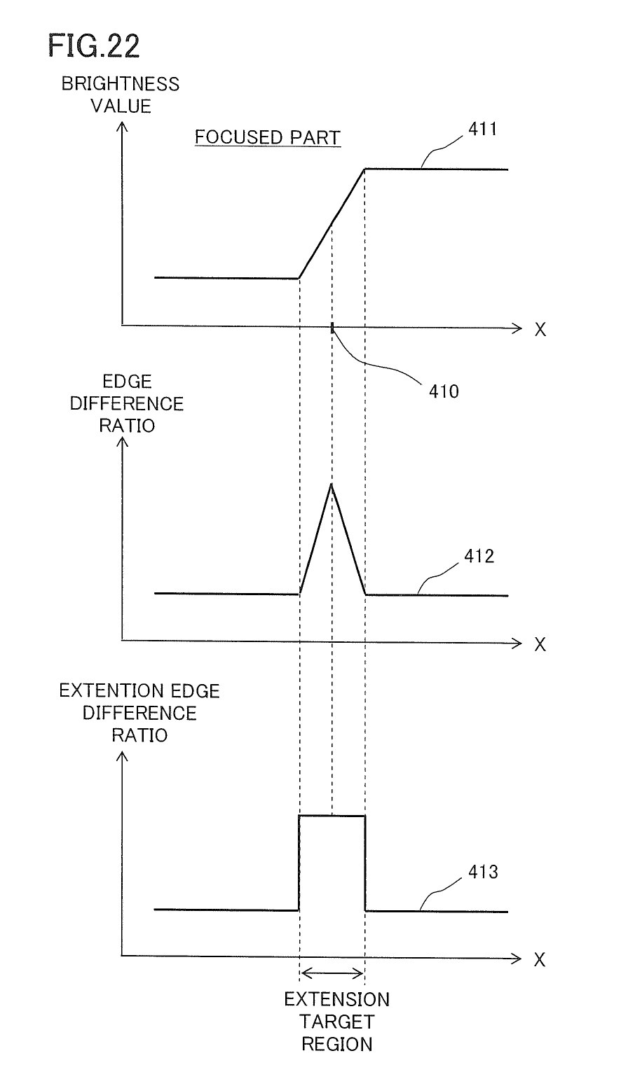

An extension processing portion 104 extends, based on the calculated edge difference ratio of each pixel, a region in which the edge difference ratio is large. Processing for performing this extension is simply referred to as extension processing; an edge difference ratio resulting from the extension processing is referred to as an extension edge difference ratio. FIG. 22 is a conceptual diagram of the extension processing performed in the extension processing portion 104. In FIG. 22, a line graph 411 represents a pattern of a typical brightness signal in a focused part on the input image; a line graph 412 represents a pattern of an edge difference ratio derived from the brightness signal represented by the line graph 411; and a line graph 413 represents a pattern of an extension edge difference ratio derived from the edge difference ratio represented by the line graph 412.

As obvious from the line graph 412, the edge difference ratio is the maximum at a point 410 that is the center portion of the edge. The extension processing portion 104 sets, at an extension target region, an image region having the point 410 arranged in the center thereof and having a predetermined size, and replaces the edge difference ratio of each pixel belonging to the extension target region with the edge difference ratio of the point 410. The edge difference ratio resulting from this replacement is an extension edge difference ratio that needs to be determined by the extension processing portion 104. In other words, the extension processing portion 104 replaces the edge difference ratio of each pixel belonging to the extension target region with the maximum edge difference ratio in the extension target region.

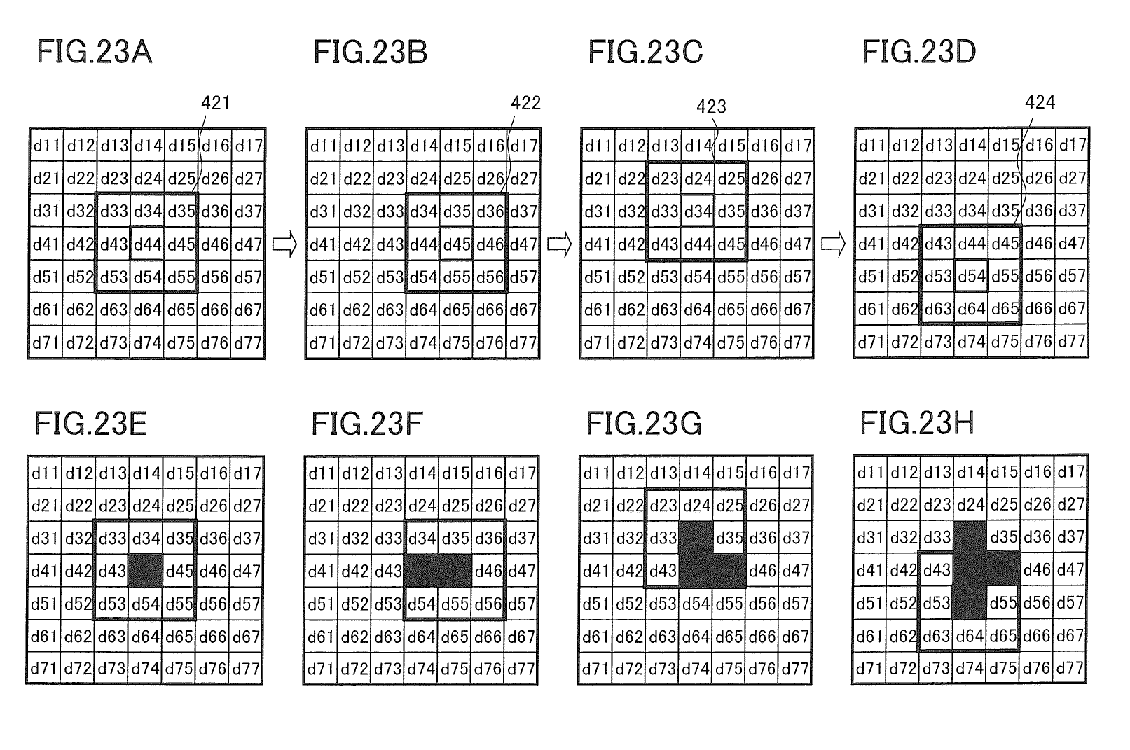

The extension edge difference ratio of the pixel (i, j) is represented by dij′. FIGS. 23A to 23H are diagrams illustrating the extension processing performed by the extension processing portion 104 of FIG. 20. FIGS. 23A to 23D show the edge difference ratios d11 to d77 of 7×7 pixels among the edge difference ratios output from the edge difference ratio calculation portion 103. In the example shown in FIG. 23A and the like, the image region of 3×3 pixels in which the noted pixel is arranged in the center thereof is made the extension target region. The extension processing is assumed to be performed in the order from FIG. 23A to FIG. 23B to FIG. 23C and to FIG. 23D. The noted pixel and the extension target region are shifted only one pixel from the state shown in FIG. 23A to the right side, to the upper side or to the lower side, and thus the state shown in FIG. 23A is brought into the state shown in FIG. 23B, FIG. 23C or FIG. 23D, respectively.

In the state shown in FIG. 23A, the pixel (4, 4) is set at the noted pixel. Hence, the image region composed of the total of 9 pixels (i, j) that satisfy 3≦i≦5 and 3≦j≦5 is set at an extension target region 421. It is now assumed that, among the edge difference ratios of 9 pixels belonging to the extension target region 421, the edge difference ratio d44 of the noted pixel (4, 4) is the maximum. In this case, the extension processing portion 104 does not perform the replacement described above on the edge difference ratio of the noted pixel (4, 4), and maintains it. In other words, the extension edge difference ratio d44′ of the noted pixel (4, 4) is made the edge difference ratio d44 itself. FIG. 23E shows a result obtained by performing the extension processing on the state shown in FIG. 23A. In FIG. 23E, a black portion represents a portion to which the extension edge difference ratio of d44 is added after the extension processing is performed (the same is true for FIGS. 23F, 23G and 23H).

In the state shown in FIG. 23B, the pixel (4, 5) is set at the noted pixel, and an extension target region 422 is set for the noted pixel (4, 5). When d44 is assumed to be the maximum among the edge difference ratios of 9 pixels belonging to the extension target region 422, the extension processing portion 104 replaces the edge difference ratio d45 of the noted pixel (4, 5) with d44. That is, d45′=d44. FIG. 23F shows a result obtained by performing the extension processing on the states shown in FIGS. 23A and 23B.

In the state shown in FIG. 23C, the pixel (3, 4) is set at the noted pixel, and an extension target region 423 is set for the noted pixel (3, 4). When d44 is assumed to be the maximum among the edge difference ratios of 9 pixels belonging to the extension target region 423, the extension processing portion 104 replaces the edge difference ratio d34 of the noted pixel (3, 4) with d44. That is, d34′=d44. FIG. 23G shows a result obtained by performing the extension processing on the states shown in FIGS. 23A to 23C.

In the state shown in FIG. 23D, the pixel (5, 4) is set at the noted pixel, and an extension target region 424 is set for the noted pixel (5, 4). When d44 is the maximum among the edge difference ratios of 9 pixels belonging to the extension target region 424, the extension processing portion 104 replaces the edge difference ratio d54 of the noted pixel (5, 4) with d44. That is, d54′=d44. FIG. 23H shows a result obtained by performing the extension processing on the states shown in FIGS. 23A to 23D.

The extension processing as described above is performed on all the pixels. With this extension processing, since the region of the edge portion is extended, a boundary between a subject in focus and a subject out of focus is made clear.

When a subject in the pixel (i, j) is in focus, the extension edge difference ratio dij′ is relatively large whereas when the subject in the pixel (i, j) is not in focus, the extension edge difference ratio dij′ is relatively small. Hence, in the first focus degree derivation method, the extension edge difference ratio dij′ is used as a focus degree FD (i, j) of the pixel (i, j). The edge difference ratio dij before being subjected to the extension processing can also be used as the focus degree FD (i, j) of the pixel (i, j).

—Second Focus Degree Derivation Method—

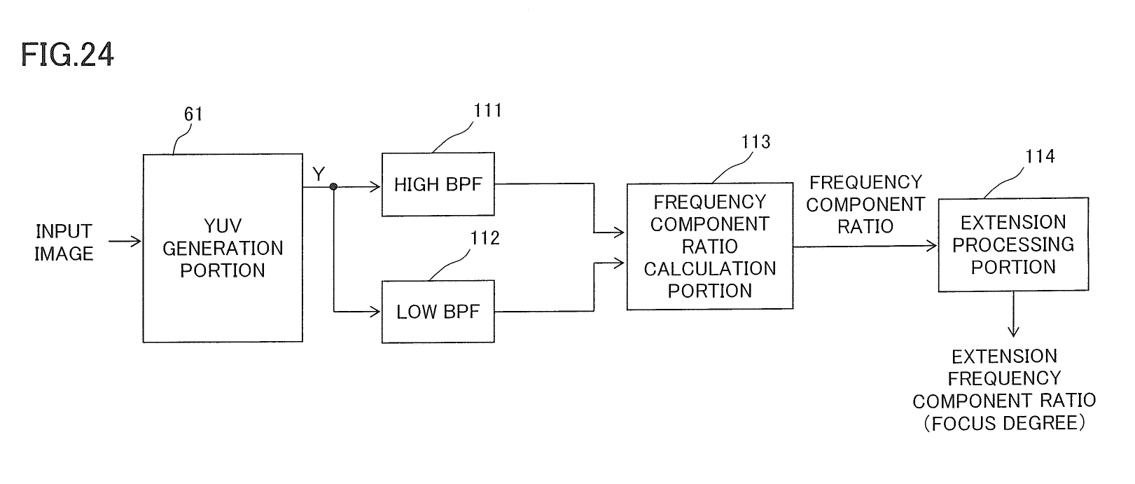

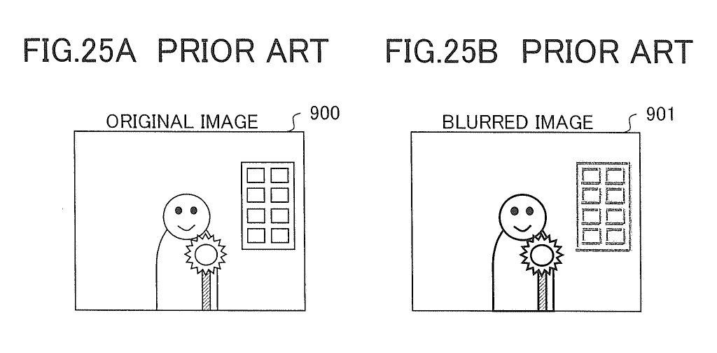

The second focus degree derivation method will be described. FIG. 24 is a block diagram of portions that derive the focus degree in the second focus degree derivation method. The YUV generation portion 61 of FIG. 24 is the same as shown in FIG. 15 and the like. The portions represented by reference numerals 111 to 114 in FIG. 24 can be provided in the focus degree map generation portion 51 of FIG. 4.

A high BPF 111 is a band pass filter that extracts a brightness signal including spatial frequency components within a pass band BAND_{H} from brightness signals output from the YUV generation portion 61, and that outputs it; a low BPF 112 is a band pass filter that extracts a brightness signal including spatial frequency components within a pass band BAND_{L} from the brightness signals output from the YUV generation portion 61, and that outputs it. In the high BPF 111, spatial frequency components outside the pass band BAND_{H} are removed; in the low BPF 112, spatial frequency components outside the pass band BAND_{L} are removed. The removal in the high BPF 111 and the low BPF 112 means the complete removal of a target to be removed or removal of part of the target. The removal of part of the target can also be said to be reduction of the target.

The center frequency of the pass band BAND_{H} in the high BPF 111 is higher than that of the pass band BAND_{L} in the low BPF 112. The cutoff frequency on the lower frequency side in the pass band BAND_{H} is higher than that on the lower frequency side in the pass band BAND_{L}; the cutoff frequency on the higher frequency side in the pass band BAND_{H} is higher than that on the higher frequency side in the pass band BAND_{L}.

The high BPF 111 performs a frequency domain filtering corresponding to the pass band BAND_{H} on a grey image composed of only brightness signals of the input image, and thereby can obtain a grey image after being subjected to the frequency domain filtering corresponding to the pass band BAND_{H}. The low BPF 112 performs processing in the same manner and thereby can obtain a grey image.

A frequency component ratio calculation portion 113 calculates a frequency component ratio for each pixel based on the output value of the high BPF 111 and the output value of the low BPF 112. The brightness value of the pixel (i, j) on the grey image obtained from the high BPF 111 is represented by eij; the brightness value of the pixel (i, j) on the grey image obtained from the low BPF 112 is represented by fij; and the frequency component ratio of the pixel (i, j) is represented by gij. Then, the frequency component ratio calculation portion 113 calculates the frequency component ratio for each pixel according to an equation “gij=|eij/fij|.”

An extension processing portion 114 performs the same extension processing as that performed in the extension processing portion 104 of FIG. 20. While the extension processing portion 104 performs the extension processing on the edge difference ratio dij to derive the extension edge difference ratio dij′, the extension processing portion 114 performs the extension processing on a frequency component ratio gij to derive an extension frequency component ratio gij′. The method of deriving, by the extension processing portion 104, the extension edge difference ratio from the edge difference ratio is the same as the method of driving, by the extension processing portion 114, the extension frequency component ratio from the frequency component ratio.

When a subject in the pixel (i, j) is in focus, the extension frequency component ratio gij′ is relatively large whereas when the subject in the pixel (i, j) is not in focus, the extension frequency component ratio gij′ is relatively small. Hence, in the second focus degree derivation method, the extension frequency component ratio gij′ is used as the focus degree FD (i, j) of the pixel (i, j). The frequency component ratio gij before being subjected to the extension processing can also be used as the focus degree FD (i, j) of the pixel (i, j).

—Third Focus Degree Derivation Method—

The third focus degree derivation method will be described. The focus degree map generation portion 51 of FIG. 4 can also generate the focus degree map based on an instruction from the user. For example, after the input image is shot, with the input image displayed on the display portion 15, a focus degree specification operation on the operation portion 17 is received from the user. Alternatively, when the display portion 15 has the touch panel function, the focus degree specification operation performed by the user through the touch panel operation is received. The focus degree specification operation is performed to specify the focus degree of each pixel on the input image. Therefore, in the third focus degree derivation method, the details of the focus degree specification operation function as the focus degree derivation information (see FIG. 4).

For example, the user is made to specify, among all image regions of the input image, an image region necessary to have a first focus degree, an image region necessary to have a second focus degree, . . . and an image region necessary to have an nth focus degree (n is an integer equal to or more than two). Thus, it is possible to generate the focus degree map according to the specified details. Here, the first to nth focus degrees are assumed to be different from each other.

—Fourth Focus Degree Derivation Method—

The fourth focus degree derivation method will be described. In the fourth focus degree derivation method, the focus degree map is generated based on a range image that has, a pixel value, the subject distance of the subject of each pixel on the input image and the focal length of the image sensing portion 11 at the time of shooting of the input image. Hence, in the fourth focus degree derivation method, the range image and the focal length described above function as the focus degree derivation information (see FIG. 4). Since the focal length is determined and thus the subject distance that is brought in focus most clearly is determined, the focus degree map is preferably generated such that the largest focus degree (hereinafter simply referred to as an upper limit focus degree) is allocated to the subject distance (hereinafter referred to as a focus distance) that is brought in focus most clearly and that, as the subject distance of the noted pixel is moved away from the focus distance, the focus degree of the noted pixel is reduced from the upper limit focus degree.

Any method of generating the range image may be used. For example, the image sensing device 1 uses a distance measuring sensor (not shown) for measuring the subject distance of each pixel on the input image, and thereby can generate the range image. As the distance measuring sensor, any known distance measuring sensor, such as a distance measuring sensor based on a triangulation method, can be used.

—Fifth Focus Degree Derivation Method—

The fifth focus degree derivation method will be described. In the fifth focus degree derivation method, the focus degree map is generated using the light field method described previously. Hence, in the fifth focus degree derivation method, the image signal of the input image (in particularly, the original input image) functions as the focus degree derivation information (see FIG. 4).

When the light field method is used as described above, since the output signal of the image sensor 33 that is the source of the image signal of the input image includes the information on the direction in which the light enters the image sensor 33, it is possible to derive, based on the image signal of the input image, through computation, how much focus is achieved on the image in each position on the input image. As described above, since the focus degree is a degree that indicates how much focus is achieved, it is possible to derive, based on the image signal of the input image by the light field method, through computation, the focus degree in each pixel position on the input image (in other words, it is possible to generate the focus degree map).

—Sixth Focus Degree Derivation Method—

The sixth focus degree derivation method will be described. In the sixth focus degree derivation method, the image signal of the input image (in particularly, the original input image) functions as the focus degree derivation information (see FIG. 4). As a map representing a degree indicating how much the attention of a person is visually attracted, a saliency map is known. An image portion in which the attention is more visually attracted can be considered to be an image portion where the main subject needed to be in focus is present; the image portion can also be considered to be a focused part. In view of the foregoing, in the sixth focus degree derivation method, a saliency map that is derived on the input image is generated as the focus degree map. As a method of deriving a saliency map of the input image based on the image signal of the input image, any known method can be used.

<<Variations and the Like>>

Specific values indicated in the above description are simply illustrative; they can be naturally changed to various values. As explanatory notes that can be applied to the above embodiments, explanatory notes 1 to 4 will be described below. The details of the explanatory notes can be freely combined unless a contradiction arises.

[Explanatory Note 1]

Although, in the embodiments described above, the output image generation processing and the processing for deriving the focus degree are performed for each of the pixels of the input image, these processing may be performed for each block composed of a plurality of pixels.

For example, all image regions of the input image are divided into blocks having a size of 3×3 pixels, and the focus degree is derived for each of the blocks based on the focus degree derivation information, and thus the focus degree map is generated. For example, when the configuration of FIG. 17 is employed, the output image may be generated by deriving the combination ratio of each block from the generated focus degree map and combining the input image and the entire scene blurred image from the entire scene blurring portion 72 for each block according to the combination ratio of each block.

When the pixel-by-pixel processing and the block-by-block processing are summarized, they can be expressed as follows. An arbitrary two-dimensional image such as the input image is composed of a plurality of small regions, and the output image generation processing and the processing for deriving the focus degree can be performed for each of the small regions. Here, the small region refers to an image region formed with one pixel (in this case, the small region is a pixel itself) or the block composed of a plurality of pixels and described above.

[Explanatory Note 2]

As described above, the input image that needs to be supplied to the output image generation portion 53 of FIG. 4 and the like may be each frame (that is, a frame image) of a moving image resulting from shooting by the image sensing portion 11. Now, the moving image that results from shooting by the image sensing portion 11 and that needs to be recorded in the recording medium 16 is referred to as a target moving image. In this case, the focus degree map is generated for all frames that constitute the target moving image, the record target image that is either a frame or an output image based on the frame is generated for each of the frames and the record target image and the focus degree map can be recorded, for each of the frames, in the recording medium 16 with the record target image and the focus degree map associated with each other or the record target image can be recorded in the recording medium 16 with the focus degree map embedded in the record target image.

For example, in order for necessary recording capacity to be reduced, the focus degree map may be recorded for only part of the frames. For example, the focus degree map may be recorded every Q frames (Q is an integer equal to or more than two). Specifically, for example, the ith frame, the (i+Q)th frame, the (i+2×Q)th frame, . . . that form the target moving image are set at the target frames, only the target frames are treated as the input image and the focus degree map for each of the target frames is generated (i is an integer). The record target image that is either the target frame or the output image based on the target frame is generated for each of the target frames, and the record target image and the focus degree map may be recorded, for each of the target frames, in the recording medium 16 with the record target image and the focus degree map associated with each other or the record target image may be recorded in the recording medium 16 with the focus degree map embedded in the record target image. In this case, frames (hereinafter referred to as non-target frames) other than the target frames are recorded in the recording medium 16 as part of the target moving image; the focus degree map for the non-target frame is not recorded in the recording medium 16.

When the focus degree map for the non-target frame is necessary, the focus degree map for the target frame close in time to the non-target frame is used, and thus it is possible to generate the focus degree map for the non-target frame. For example, when the (i+1)th frame is the non-target frame, focus degree maps for the ith frame and the (i+Q)th frame that are the target frames are read from the recording medium 16, and one of the two focus degree maps that are read or a focus degree map obtained by averaging the two focus degree maps that are read may be generated as the focus degree map for the (i+1)th frame.

[Explanatory Note 3]

Although, in the above embodiments, the digital focus portion 50 and the recording medium 16 are assumed to be provided within the image sensing device 1 (see FIGS. 1 and 4), the digital focus portion 50 and the recording medium 16 may be incorporated in an electronic device (not shown) different from the image sensing device 1. Electronic devices include a display device such as a television set, a personal computer and a mobile telephone; the image sensing device is also one type of electronic device. The image signal of the input image resulting from shooting by the image sensing device 1 is transmitted to the electronic device through the recording medium 16 or by communication, and thus it is possible to generate an output image from an input image in the digital focus portion 50 within the electronic device. In this case, when the focus degree derivation information is different from the image signal of the input image, it is preferable to additionally transmit the focus degree derivation information to the electronic device.

[Explanatory Note 4]

The image sensing device 1 of FIG. 1 can be formed with hardware or a combination of hardware and software. When the image sensing device 1 is formed with software, a block diagram of portions that are provided by software indicates a functional block diagram of those portions. By writing, as a program, a function achieved with software and performing the program on a program execution device (for example, computer), the function may be achieved.

What is claimed is:

1. An electronic device comprising:
a focus degree map generation portion that generates a focus degree map indicating a focus degree in each position on an input image;
an output image generation portion that performs image processing corresponding to the focus degree map on the input image to generate an output image; and
a record control portion that sets the input image or the output image at a record target image and that records the record target image and the focus degree map in a recording medium such that the record target image and the focus degree map are associated with each other or that records the record target image in the recording medium such that the focus degree map is embedded in the record target image.

2. The electronic device of claim 1, further comprising:
a focus degree map edition portion that edits the focus degree map according to an edition instruction,
wherein the output image generation portion uses an edited focus degree map to generate the output image, and
the record control portion either records the record target image and the edited focus degree map in the recording medium such that the record target image and the edited focus degree map are associated with each other or records the record target image in the recording medium such that the edited focus degree map is embedded in the record target image.

3. The electronic device of claim 1
wherein the record control portion also records, in the recording medium, processing performance information indicating whether or not the record target image is an image resulting from the image processing such that the processing performance information is associated with the record target image.

4. The electronic device of claim 1
wherein, when the record target image is the output image,
the record control portion records, in the recording medium, a first image file storing the input image, and records, in the recording medium, a second image file storing the output image, the focus degree map and link information on the first image file.

5. The electronic device of claim 4
wherein, when an instruction to perform the image processing on the output image within the second image file is provided after the first and second image files are recorded in the recording medium,
the output image generation portion uses the link information to read the input image from the first image file, and performs image processing corresponding the focus degree map on the read input image such that a new output image is generated.

6. The electronic device of claim 1
wherein the record control portion stores the focus degree map in a record region within an image file storing the record target image.
